(19) United States
(12) Patent Application Publication
(10) Pub. No.: US 2025/0007600 A1
(43) Pub. Date: Jan. 2, 2025

(54) ESTIMATION AND USE OF WIRELESS CHANNEL PARAMETERS

(71) Applicant: Intel Corporation, Santa Clara, CA (US)

(72) Inventors: Yang-Seok Choi, Portland, OR (US); Sagar Dhakal, Los Altos, CA (US); Husam Elfadil, Cedar Park, TX (US); Thushara Hewavithana, Tempe, AZ (US); Xiaofeng Li, Elk Grove, CA (US); Peng Lu, Elk Grove, CA (US); Tariq Qureshi, Hillsboro, OR (US); Jan Schreck, San Jose, CA (US)

(21) Appl. No.: 18/344,191

(22) Filed: Jun. 29, 2023

(51) Int. Cl. H04B 7/08; H04B 7/0426; H04B 7/06

(52) U.S. Cl. CPC H04B 7/0854; H04B 7/0426; H04B 7/0617; H04B 7/0626

(57) ABSTRACT

Techniques are disclosed to address issues related to the computation of channel state information (CSI) and angular spectrum (AS) to perform beamforming. The CSI and AS, as well as various statistical channel parameters of a wireless channel, may be computed using different techniques, which include the use of domain knowledge enhanced neural networks (DKE-NNs). The CSI and AS may be further utilized to perform beamforming using various techniques. One of these techniques may include the implementation of eigen beamforming, which provides artificially generated power at locations within the AS that are identified with estimated eigenvector beam locations. As a result of the artificially-generated power, the resulting vector decomposition used to provide the beamforming weights results in widened eigenvector beams.

### TECHNICAL FIELD

The disclosure described herein generally relates to the estimation of wireless channel parameters and, in particular, to the estimation of wireless channel parameters using neural network architectures, as well as the use of the estimated wireless channel parameters for beamforming.

### BACKGROUND

Wireless communication transmitters and receivers require knowledge of underlying wireless channel parameters, which may alternatively be referred to herein as statistical channel parameters. Such wireless statistical channel parameters may comprise the power delay profile (PDP), timing offset (TO), maximum delay spread (MDS), Angle of Arrival (AoA) information, etc. These statistical channel parameters may be used for various applications in wireless communications, such as the computation of the channel state information (CSI), as well as for performing beamforming. For instance, to perform beamforming, a receiver or a transmitter requires an accurate measurement of the CSI, which includes the instantaneous impulse response of the channel or statistics of the channel that may be determined from the statistical channel parameters. However, conventional or “optimal” estimators are in general impractical to implement in real time for this purpose given the computational overhead.

Moreover, the CSI is typically computed using a measurement that relies upon statistical channel parameters that are derived from periodically transmitted sounding reference symbols (SRS). The CSI is then used to perform beamforming via the computation of beamforming weights per antenna. But because channel conditions are dynamic in nature, particularly when a communication device is mobile, the received SRS may be outdated, resulting in inaccurate beamforming weights being used for communications, resulting in poor performance. Thus, the means by which the statistical channel parameters are estimated to obtain the CSI, as well as the application of these parameters to perform beamforming, is inadequate.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the techniques discussed herein. In the drawings, like reference characters generally refer to the same parts throughout the different views. The drawings are not necessarily to scale, emphasis instead generally being placed upon illustrating the principles of the disclosure.

The present disclosure will be described with reference to the accompanying drawings. The drawing in which an element first appears is typically indicated by the leftmost digit(s) in the corresponding reference number.

In the following description, reference is made to the following drawings, in which:

FIG. 1 illustrates a wireless communication environment, in accordance with the present disclosure;

FIG. 2 illustrates a block diagram identified with the generation of training data, in accordance with the present disclosure;

FIG. 3 graphically illustrates a power delay profile (PDP) quantization model, in accordance with the present disclosure;

FIG. 4 illustrates a uniform planar array that is associated with the quantized Angular Spectrum (AS), in accordance with the present disclosure;

FIG. 5 illustrates channel quantization in the angle domain and the delay domain, in accordance with the present disclosure;

FIG. 6A illustrates a training architecture for a first domain knowledge enhanced neural network (DKE-NN) model, in accordance with the present disclosure;

FIG. 6B illustrates a training architecture for a second domain knowledge enhanced neural network (DKE-NN) model, in accordance with the present disclosure;

FIG. 6C illustrates a training architecture for a third domain knowledge enhanced neural network (DKE-NN) model, in accordance with the present disclosure;

FIG. 7A illustrates an inference engine architecture for the first domain knowledge enhanced neural network (DKE-NN) model as shown in FIG. 6A, in accordance with the present disclosure;

FIG. 7B illustrates an inference engine architecture for the second domain knowledge enhanced neural network (DKE-NN) model as shown in FIG. 6B, in accordance with the present disclosure;

FIG. 7C illustrates an inference engine architecture for the third domain knowledge enhanced neural network (DKE-NN) model as shown in FIG. 6C, in accordance with the present disclosure;

FIG. 8 illustrates a true (genie) PDP of a 3GPP TDLA channel model along with the PDP estimate obtained from the DKE-NN inference engine as shown in FIG. 7A, in accordance with the present disclosure;

FIG. 9 illustrates the MSE performance of a 3GPP TDLA channel model compared to the DKE-NN inference engine as shown in FIG. 7A, in accordance with the present disclosure;

FIG. 10 illustrates a PDP estimate for a customized channel model computed using the DKE-NN as shown in FIG. 7A, in accordance with the present disclosure;

FIG. 11 illustrates denoising performance of the DKE-NN inference engine as shown in FIG. 7A in a two cluster channel model, in accordance with the present disclosure;

FIG. 12 illustrates AoA estimation using the DKE-NN inference engine as shown in FIG. 7A compared to an MLE estimate, in accordance with the present disclosure;

FIG. 13 illustrates a computing device, in accordance with the present disclosure;

FIG. 14 illustrates a process flow, in accordance with the present disclosure;

FIG. 15 illustrates a widened eigen beam pattern compared to conventional eigen beams, in accordance with the present disclosure;

FIG. 16 illustrates a block diagram identified with the generation of wide eigenvector beamforming weights, in accordance with the present disclosure;

FIG. 17A illustrates an angular spectrum with two main beam locations, in accordance with the present disclosure;

FIG. 17B illustrates an angular spectrum showing wide eigen beams after the injection of artificial power, in accordance with the present disclosure;

FIG. 18 illustrates a simulation result corresponding to the generation of a widened two-finger eigen beam, in accordance with the present disclosure;

FIG. 19 illustrates a process flow, in accordance with the present disclosure;

FIG. 20 illustrates a block diagram of an O-RAN architecture, in accordance with the disclosure;

FIG. 21 illustrates simulated performance of normalized spectral efficiency in a stationary channel model, in accordance with the disclosure; and

FIG. 22 illustrates simulated performance normalized spectral efficiency in a non-stationary channel model, in accordance with the disclosure.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The implementations as described herein are divided into separate Sections for ease of explanation. However, these implementations may be separately utilized or combined with one another. The first Section is directed to addressing issues related to the estimation of statistical channel parameters and the CSI. The second Section is directed to addressing issues related to using the CSI to perform beamforming, which implements wide eigenvector beams for beamforming. The beamforming described in the second Section may be performed using the CSI and/or statistical channel parameters as estimated in the first Section, or using alternate techniques.

### Section I—the Use of Neural Networks for Estimating Statistical Channel Parameters and Channel State Information (CSI)

Again, real-time implementation using optimal estimators to estimate statistical channel parameters is impractical. As a result, alternative techniques have been conventionally implemented to obtain this information. For instance, timing offset (TO) estimation may conventionally be performed by correlating received in-phase and quadrature (IQ) samples with a known pilot sequence. However, due to inter-symbol interference present in a wireless channel, this correlation-based approach has residual timing error. Another technique includes estimating the power delay profile (PDP) via an inverse Fourier Transform of received pilot symbols, although such linear methods suffer from sidelobe leakage in the estimated PDP in a narrow bandwidth signal.

Still further, conventional techniques include the use of multiple signal classification (MUSIC) to estimate the angle of arrival (AoA). MUSIC functions by utilizing the antenna array to perform exhaustive sub-space processing to resolve different AoAs. However, the primary disadvantage of MUSIC is the high computational complexity associated with such exhaustive searches. Finally, other conventional techniques for the estimation of statistical channel parameters include the rotational invariance techniques (ESPIRIT), which is another subspace based AoA estimation method. However, ESPIRIT techniques may provide poor accuracy in a rich-scattering high-mobility fading environment.

Thus, this Section is directed to new techniques for modeling the statistical channel parameters that allow for the use of optimal estimators to generate data for offline training of a domain knowledge enhanced Neural Network (DKE-NN) model. Then, during online inference, the DKE-NN computes near-optimal estimates of the channel parameters at a fraction of computational complexity of conventional systems. To do so, a particular statistical channel parameter such as PDP that is to be estimated is quantized into uniformly spaced delay bins up to a cyclic prefix length, and a log likelihood cost function is thereby obtained that is parameterized by power in each delay bin.

Next, it is further noted that angular spectrum (AS) is the distribution of received power over angle of arrivals (AoA). Thus, another statistical channel parameter such as the angular spectrum (AS) may be determined by quantizing the AoA into uniformly spaced angular bins in the azimuth and elevation directions, and a log likelihood cost function is thus obtained that is parameterized by power in each angular bin. Then during inference, the AS estimation is performed based upon the observed CSI. Synthetic data is then generated by solving for the maximum likelihood estimate of the particular channel parameters, such as PDP and AS, as well as corresponding Lagrange multipliers. Finally, a domain knowledge enhanced Neural Network (DKE-NN) may be implemented that is trained using the synthetic data. The proposed DKE-NN models as discussed in this Section provide near maximum likelihood estimates of the particular statistical channel parameters that are estimated, such as PDP and AS, within the computing budget required for sub-frame level processing. Such highly accurate PDP and AS estimates may achieve several dBs improvements in channel estimation and beamforming performance.

Once trained, the DKE-NN may be deployed and implemented at inference to estimate statistical channel parameters based upon received signals. These statistical channel parameters may, in turn, be used to perform any suitable type of beamforming techniques, which may include those as further discussed below in Section II.

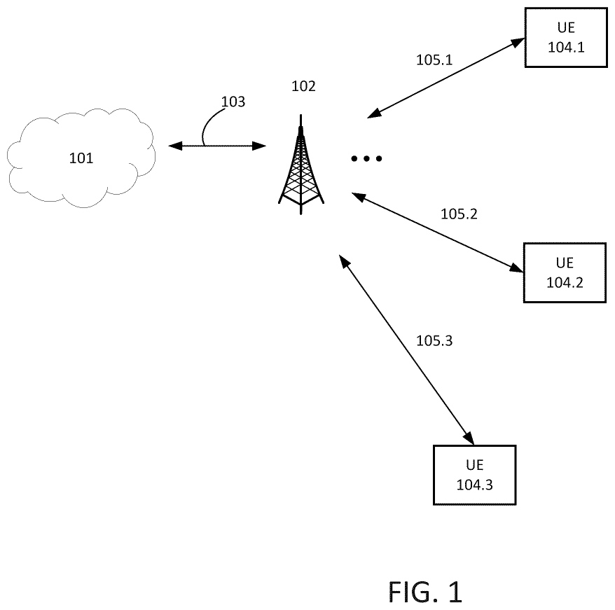

FIG. 1 illustrates a wireless communication environment, in accordance with the present disclosure. As shown in FIG. 1, the wireless communication environment 100 comprises any suitable number and/or type of various communication networks, base stations, and user equipment's (UEs), and may include additional or alternative components that are typically identified with wireless communication networks.

The wireless communication environment 100 comprises a base station 102, which is communicatively coupled to a core network 101 via the link(s) 103. The core network 101 may be comprised of any suitable number and/or type of computing systems, networks, etc. The core network 101 thus represents a primary supporting network, and may comprise cloud computing systems or any other suitable type of networks, computing systems, platforms, etc., including known systems, to support core network functionality. The link(s) 103 thus represent any suitable number and/or type of connections including wireless connections, wired connections, or combinations of these, which enable the base station 102 to service each of the connected UEs 104 by providing access to the core network 101.

The base station 102 may form part of a larger network, and may alternatively be identified with other type of network components such as picocells, macrocells, femtocells, routers, access points, etc. The wireless communication environment 100 may additionally comprise any suitable number and/or type of user equipment's (UEs) 104, with three UEs 104.1-104.3 being shown in FIG. 1 for purposes of brevity. The UEs 104.1-104.3 may be implemented as any suitable type of communication device configured to perform wireless communications, such as a mobile phone, computer, laptop, tablet, wearable device, etc. The UEs 104.1-104.3 may be each be communicatively coupled to the base station 102 via respective links 105.1-105.3, which may represent any suitable number and/or type of connections including wireless connections, wired connections, or combinations of these, and which enable the UEs 104.1-104.3 to communicate with the base station 102 and, in turn, the core network 101. Thus, the UEs 104.1-104.3 may implement wireless communications by way of the links 105.1-105.3.

The wireless communication environment 100, and the various components identified with the wireless communication environment 100, may operate in accordance with any suitable number and/or type of communication networks, protocols, standards, radio access technologies (RATs), etc. This may comprise, in various illustrative and non-limiting scenarios, any suitable type of cellular standard, which may comprise a 3GPP standard, including new radio (NR) standards, the most recent as of this time of writing being 3GPP R16 published in June 2019, and which may comprise communication protocols that are currently and commonly referred to as “5G” protocols, long-term evolution (LTE) protocols, LTE/LTE-A, Wifi 802.11 standards, etc. Thus, the disclosure as further discussed herein may be implemented to perform beamforming and wireless communications in accordance with any of these communication networks, protocols, standards, radio access technologies (RATs), etc., which are provided as a non-limiting and illustrative scenario, and may additionally or alternatively comprise other communication standards such as the Open Radio Access Network (O-RAN).

The various techniques as discussed herein may be implemented via various computing devices, and may leverage neural networks or other suitable architectures. As further discussed below, such architectures may be implemented via any suitable computing device, which may include the UEs 104 and/or computing devices identified with, communicatively coupled to, and/or integrated as part of the base station 102 and/or the core network 101.

### A. Training Data Generation

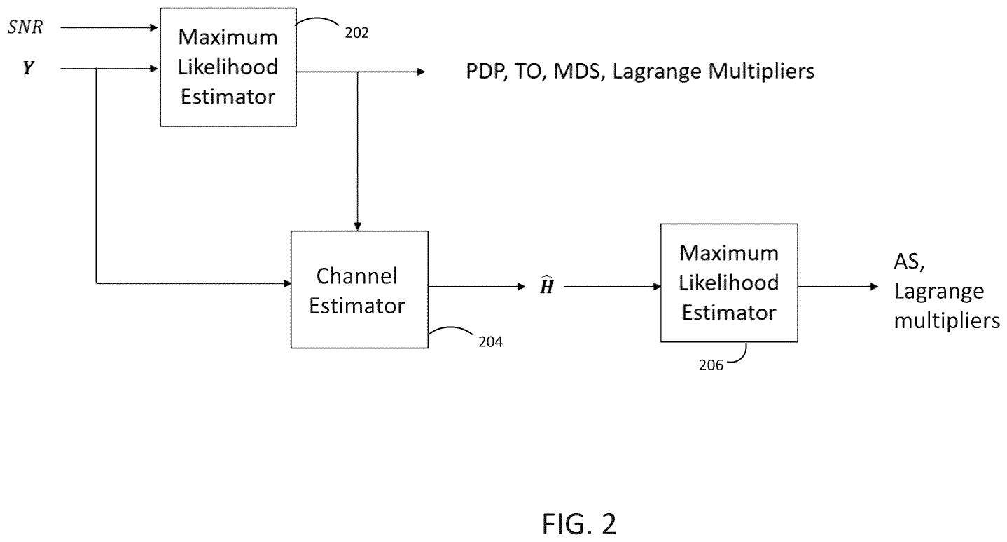

FIG. 2 illustrates a block diagram identified with the generation of training data, in accordance with the present disclosure. FIG. 2 illustrates how the flow of data may be implemented to generate the training data as discussed in further detail herein and in Appendices A and B. Each of the MLE blocks 202, 206 and the channel estimator block 204 may be implemented as any suitable type of hardware circuitry, executable software, or combinations of these to perform their respective functions. The architecture 200 as shown in FIG. 2 may comprise part of the same computing device that implements the neural network architectures as further discussed herein. Alternatively, the architecture 200 may be identified with a separate computing device that generates the training data, which is then stored and provided for neural network training as further discussed below.

As noted above, conventional techniques for estimating statistical channel parameters, which may be used to perform channel estimation and beamforming, have various drawbacks. The disclosure addresses these issues by utilizing neural network architectures that are trained in accordance with synthetic training data. This training data is derived from the use of a multipath propagation channel model that applies predefined signal parameters to generate training samples. The training samples thus emulate the properties of signals that are anticipated to be received during inference, and may be used to generate corresponding labels that comprise a maximum likelihood estimation (MLE) of statistical channel parameters such as a power delay profile (PDP), timing offset (TO), maximum delay spread (MDS), angular spectrum (AS), angle of arrival (AoA), etc., of a wireless channel.

The training samples are represented in FIG. 2 as Y, with the statistical channel parameters PDP, TO, and MDS illustrated as outputs of the application of the maximum likelihood estimator (MLE) block 202. Thus, the MLE block 202 is configured to perform MLE with respect to the synthetic training samples Y to provide, for a particular training sample, one or more statistical channel parameters that are most likely identified with that training sample in an MLE sense.

In addition to the statistical channel parameters, the MLE block 202 also outputs Lagrange multipliers, which are associated with equality and inequality constraints, and may be identified with extracted underlying domain knowledge. In other words, the Lagrange multipliers for PDP estimation (block 202) correspond to a non-negativity of power (inequality constraints) in each PDP bin, and normalizes the total power across all PDP bins to 1 (equality constraint). Similarly, the Lagrange multipliers for AS estimation (block 206) correspond to a non-negativity of power in each AoA bin, and normalizes the total power across all AoA bins to 1 (equality constraint).

The estimated statistical channel parameters may then be input to a channel estimation block 204 along with the training samples Y, which estimates the channel state information Ĥ as shown in FIG. 2. The channel state information Ĥ may be computed in any suitable manner using this information, including the use of known techniques to do so. The estimated channel state information Ĥ is then input to a second MLE block 206. The MLE block 206 may thus compute, from the channel state information Ĥ, further statistical channel parameters such as angular spectrum (AS). Thus, the MLE block 206 is likewise configured to perform MLE with respect to the channel state information H to provide, for a particular estimated CSI, one or more statistical channel parameters that are most likely identified with the estimated CSI in an MLE sense. The AS thus represents a distribution of received power at different angles of arrival of a received signal across the antenna array of a receiving device. The MLE block 206 may likewise output, in addition to these further statistical channel parameters, Lagrange multipliers.

Thus, FIG. 2 demonstrates how the synthetic training data may be generated using a multipath propagation model, as further discussed herein. The training data that is subsequently used to train the neural network may comprise any subset (or all) of the statistical channel parameters such as the PDP, TO, MDS, and the AS. Additionally, the training data may comprise the Lagrange multipliers and the channel state information Ĥ, or any subset of the statistical channel parameters, the Lagrange multipliers, and/or the channel state information Ĥ. Once trained, a neural network as further described herein is configured to estimate, at inference, the statistical channel parameters of the wireless channel identified with the propagation of a received signal as well as the CSI, and to perform antenna beamforming using the statistical channel parameters and CSI.

The beamforming as discussed herein may be implemented for multiple-input multiple-output (MIMO) antenna systems, such as those utilized via base station systems, UEs, etc., and may include those discussed above with respect to FIG. 1. Thus, the received signals as discussed in further detail herein may be identified, in some non-limiting and illustrative scenarios, with signals transmitted by a UE 104 and received by the base station 102. Thus, the base station 102 may utilize the techniques as described herein to perform channel estimation and beamforming for the transmission of signals in the downlink path and/or the subsequent reception of signals in the uplink path. Of course, a UE 104 may additionally or alternatively implement the techniques as discussed herein to receive signals transmitted by the base station 102 in the downlink path, and perform channel estimation and beamforming for the transmission of signals in the uplink path and/or the subsequent reception of signals in the downlink path.

In any event, in accordance with the present disclosure, the statistical channel parameters as discussed herein may be identified with a wireless channel using an Orthogonal Frequency-Division Multiplexing (OFDM) signal that is denoted herein as Y, and which is received in Q number of sub-carriers and Nᵣ number of receive antennas. This relationship is represented below in Equation 1 as follows:

$${Y}_{m} ( k ) = {H}_{m} ( k ) + {W}_{m} ( k ) , \qquad Eqn . 1$$

where Hₘ(k) is channel of the k-th sub-carrier in the m-th receive antenna (k=0, . . . , Q−1, and m=0, . . . , Nᵣ−1), Wₘ(k) is Additive White Gaussian Noise (AWGN) with variance 1/SNR, and SNR is the signal to noise ratio.

Thus, using properties of the wireless channel and the OFDM signal, the disclosure provides multipath propagation channel models that function to apply a set of predefined signal parameters to compute corresponding statistical channel parameters such as PDP, TO, MDS, and AS, as described in further detail in Appendix A. Based on these multipath propagation channel models, a maximum likelihood estimate (MLE) may be computed to generate the data for training a neural network, which may comprise a domain knowledge enhanced neural network (DKE-NN). Thus, once trained in this way, the neural network may be implemented during online inference to estimate the statistical channel parameters of the channel as well as the CSI.

To generate the synthetic training data, training samples are first generated in accordance with Equation 1 above. Thus, each training sample may represent a Q×Nᵣ matrix of a received training (i.e. synthetic) signal Y in accordance with the evaluation of Equation 1 above, which are generated synthetically in an independent, identically distributed (IID) manner. As will be further discussed below and referenced in the Appendices, once trained, the neural network architectures as discussed herein may estimate the statistical channel parameters, which are used to estimate the CSI using information obtained in a received multipath signal, and then use the CSI to estimate the AS.

The matrix representation as shown in Equation 2 below thus represents a training sample, which comprises a number of rows equal to the number of sub-carriers in the OFDM signal, and a number of columns equal to the number of receive antennas for the applicable system. The CSI matrix Ĥ as represented in Eqn. 3 likewise comprises the same number of corresponding elements, with the entries thereof representing the CSI.

$$Y = ( \begin{matrix}{Y}_{0} ( 0 ) & … & {Y}_{{N}_{r} - 1} ( 0 ) \\ ⋮ & ⋮ & ⋮ \\ {Y}_{0} ( Q - 1 ) & … & {Y}_{{N}_{r} - 1} ( Q - 1 )\end{matrix} ) \qquad Eqn . 2$$

$$\hat{H} = ( \begin{matrix}{\hat{H}}_{0} ( 0 ) & … & {\hat{H}}_{{N}_{r} - 1} ( 0 ) \\ ⋮ & ⋮ & ⋮ \\ {\hat{H}}_{0} ( Q - 1 ) & … & {\hat{H}}_{{N}_{r} - 1} ( Q - 1 )\end{matrix} ) \qquad Eqn . 3$$

In this way, the training samples are identified with a received wireless training signal Y, which is generated via a multipath propagation channel model that applies a set of predefined signal parameters. The wireless propagation modeling may be performed in any suitable manner using any suitable values for the set of predefined signal parameters. The following description is thus not intended to be limiting, and the predefined signal parameters may be modified based upon the particular application. In a non-limiting and illustrative scenario, the wireless propagation modeling may comprise randomly selecting a number of clusters between any suitable range of values. The range of values for the clusters may be dependent upon the desired performance and/or available processing power. In the present illustrative and non-limiting scenario, the number of clusters is randomly selected between 1 and 9. Each cluster is further defined as having an average AoA within any suitable angular range, such as a range between −π to π in the azimuth π/2 and to π in the elevation. Each cluster is also associated with an average delay within a suitable range of values, such as in the range between 0 and the cyclic prefix duration.

Each cluster has equal power and a predetermined number of multipaths, such as between 1 to 10. The AoA of each multipath has an angular spread of 5 degrees in the azimuth and 2.5 degrees in the elevation. The delay of each multipath is spread within 5% of the center delay (with wrap around). Each multipath is modeled as a zero-mean complex Gaussian random variable with equal average power. Using the above described wireless propagation model, for a fixed OFDM numerology (i.e. given sub-carrier spacing, signal bandwidth, pilot spacing), and a fixed antenna array specification, a frequency domain OFDM signal is thereby generated that is representative of the training samples. The noise samples are AWGN and uniformly distributed between an SNR in the range of −10 dB and 30 dB.

The above description of the wireless propagation model is provided in a non-limiting and illustrative manner, and may be modified based upon the particular type of signal that is being modeled, the expected multipath environment, the available processing resources of the particular application, etc. Thus, the various predefined signal parameters as described above may be modified, and/or additional or alternative predefined signal parameters may be used for the wireless propagation model that is implemented to generate the training samples as discussed herein. These predefined signal parameters may comprise, in a non-liming and illustrative scenario, the range for the number of clusters, the manner in which the clusters are selected, the angular range for the average AoA, the average delay range of values, the predetermined number of multipaths, the delay of each multipath, the manner in which the multipath is modeled, the sub-carrier spacing, signal bandwidth, pilot spacing, fixed antenna array specification, type of signal (such as frequency domain OFDM), the parameters of the noise samples, etc.

Thus, the MLE block 202 as shown in FIG. 2 may receive the training samples Y and a SNR value as input data to output a MLE of various statistical channel parameters, which may be alternatively referred to herein as physical (PHY) parameters. The MLE block 202 may additionally calculate the Lagrange multipliers. Once the statistical channel parameters are computed in the manner, the channel estimator 204 may compute the estimated CSI Ĥ, and the MLE block 206 may estimate the AS as a further statistical channel parameter. The MLE block 206 may also compute the corresponding Lagrange multipliers, as shown in FIG. 2. Again, any of the statistical channel parameters, corresponding Lagrange multipliers, and CSI may form part of the training data that is used to train the neural network, as discussed in further detail below. It is also noted that FIG. 2 assumes a multi-user case in which the CSI is used to compute the AS. However, the MLE block 202 may alternatively compute the AS as part of the other statistical channel parameters for a single user (i.e. single device) scenario, although the use of the CSI may be preferable as the CSI contains less noise compared to the training samples and thus the disclosure focuses on the computation of the AS via the CSI. In other words, FIG. 2 represents a general scenario, i.e. with multi users as well as a single user. Thus, if Y is a multi-user signal, per user PDP, AS may be estimated by performing user separation first.

To provide the training data, one or more of the statistical channel parameters may be quantized and used as a set of corresponding labels with respect to the training samples Y. Thus, the architecture 200 as shown in FIG. 2 may provide, from the training samples Y, a set of corresponding labels, which may be quantized and provided as part of the training data. Thus, the labels that are provided as training data may include a MLE of any of the statistical channel parameters that are quantized within their respective domains, as well as their corresponding Lagrange multipliers. Thus, in a non-limiting and illustrative scenario, the training sample labels may comprise an MLE of power received in the quantized delay domain, an MLE of power received in the quantized angle of arrival domain, corresponding Lagrange multipliers, etc. That is, the delays are quantized into delay bins, and the AoAs are quantized into angular bins. Once quantized, the width of the bins are fixed and do not change from sample to sample. Therefore, the training data that is provided to the neural network architectures for training purposes as further discussed below may comprise the training samples and any of these corresponding labels.

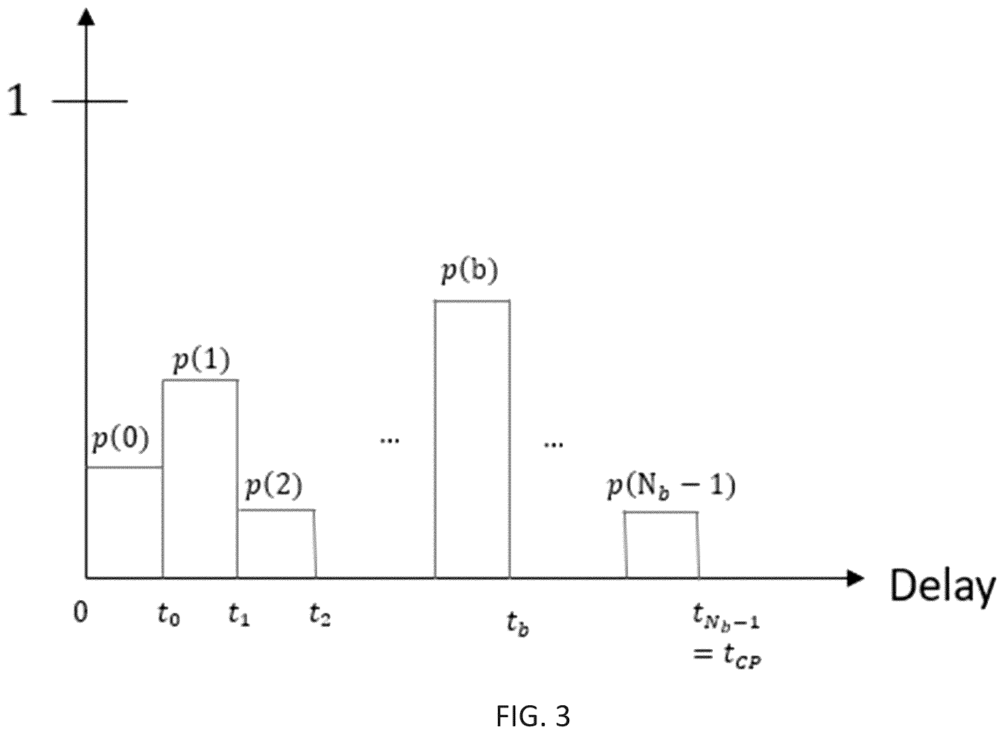

In other words, to make the PHY parameters trainable for a neural network architectures, additional modeling techniques are described in Appendix A, which demonstrates quantization in the delay domain and the angle domain. As shown in Appendix A and FIGS. 3-5, each quantization model implements any suitable number of bins based upon the respective domain. The size of the bins that are implemented in each case for the quantization of the respective PHY parameters may be modified in accordance with the available processing power, the available time to perform the neural network training, etc. Thus, the quantization modeling techniques as discussed herein enable a neural network architecture to be trained more efficiently.

Further with respect to the generation of the training data, for each quantization model as shown and described with respect to Appendix A, a log likelihood cost function is formulated, and power constraints are then applied to obtain what is referred to as a “dual problem.” A numerical algorithm is further described in Appendix B, which may be implemented to solve the dual problem, and which estimates the various statistical channel parameters from an observation Y (i.e. the training samples) while extracting underlying domain knowledge in terms of the Lagrange Multipliers.

Thus, and as shown in Appendix B, the training data used for training the neural network architectures as discussed herein comprises the input data Y (i.e. the training samples) and corresponding labels (ρ_{MLE}, α_{MLE}, λ*, μ*). As described in Appendix B, ρ_{MLE} may represent a maximum likelihood estimate of the power received in the quantized delay domain for PDP estimation, and α_{MLE} may represent the maximum likelihood estimate of the power received in the quantized angle of arrival domain for AoA estimation. Finally, λ* and μ* are Lagrange multipliers associated to the equality and inequality constraints for each of ρ_{MLE}, α_{MLE}.

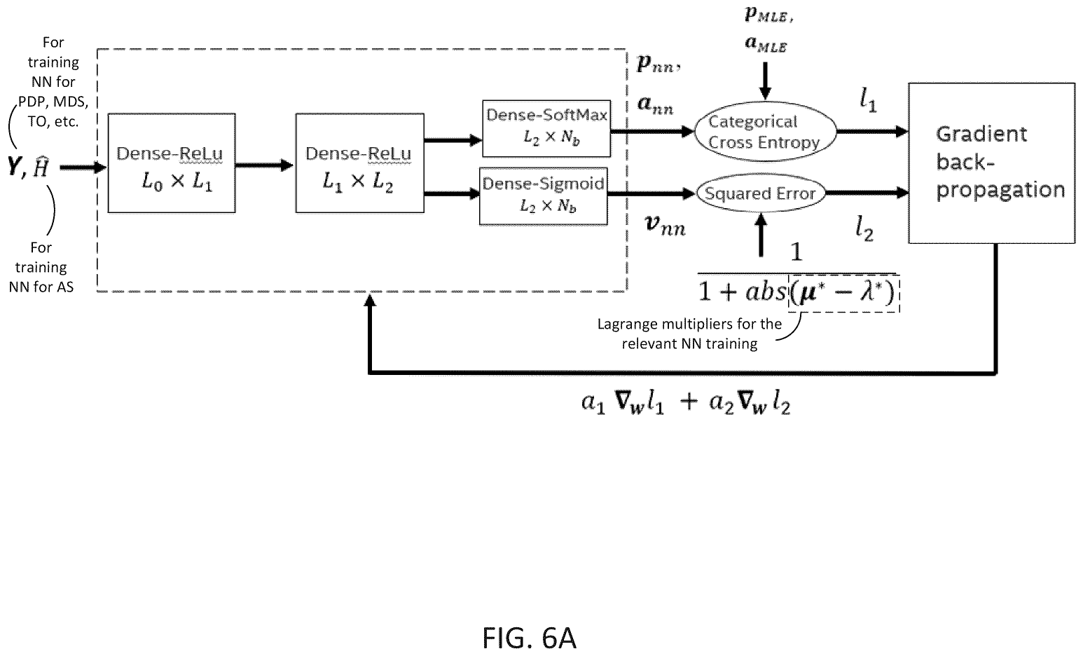

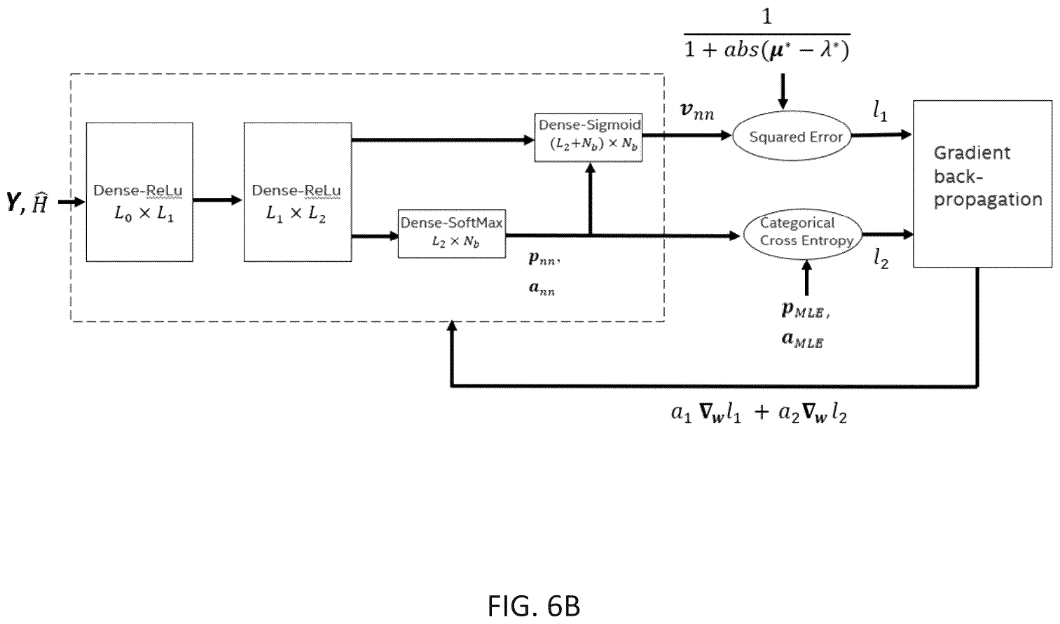

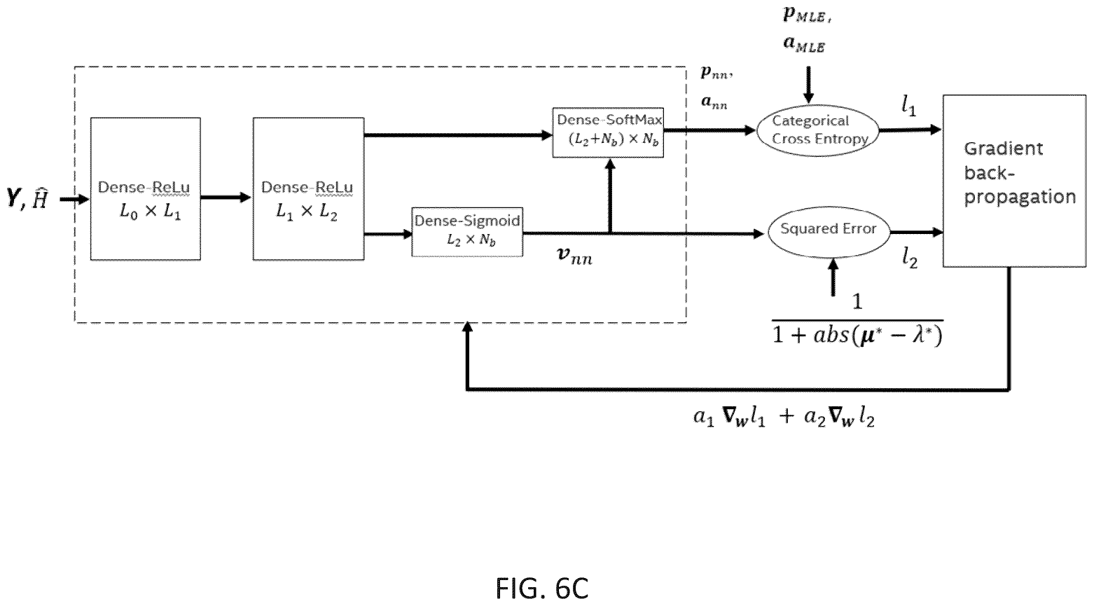

Each of the training architectures as shown and discussed below with respect to FIGS. 6A-6C are described in terms of training a domain knowledge enhanced neural network (DKE-NN) model. However, these are provided as non-limiting and illustrative scenarios, and the techniques described herein may be implemented in accordance with any suitable type of machine learning architecture, which may include alternative neural network architectures. Moreover, the various neural network architectures as discussed herein may comprise additional or alternate layers, configurations, activation functions, loss function weightings, etc.

Still further, the DKE-NN models as discussed below are illustrated as being trained in accordance with the statistical channel parameters ρ_{MLE}, α_{MLE}, which in these illustrative and non-limiting scenarios may represent a maximum likelihood estimate of the power received in the quantized delay domain for PDP estimation, and the maximum likelihood estimate of the power received in the quantized angle of arrival domain for AoA estimation, respectively. However, the DKE-NN models may be trained in accordance with any suitable number and/or type of statistical channel parameters, which may be used to determine the CSI, the AS, or other suitable information regarding a wireless channel.

Moreover, and as further discussed below, the training and inference processes may comprise multiple stages. That is, during training, each stage may utilize a different subset of the generated training data, and at inference each stage may provide an estimate of a corresponding statistical channel parameter for which the DKE-NN has been trained to estimate. These stages may be implemented by the same DKE-NN architecture or, alternatively, by separate DN-ENN architectures. In any event, for the first of these stages, the DKE-NN model is trained using the generated training samples Y to estimate any of the statistical channel parameters that are shown and discussed above with respect to the output of the MLE block 202. For the second of these stages, the DKE-NN model is trained using the CSI Ĥ to reproduce any of the statistical channel parameters that are shown and discussed above with respect to the output of the MLE block 206. Thus, both sets of training data and estimations are shown in the Figures for purposes of brevity, although it will be understood that the training and inference is each performed using a respective set of training data to perform estimations of specific statistical channel parameters in each case.

### B. Neural Network Architectures

FIG. 6A illustrates a training architecture for a first domain knowledge enhanced neural network (DKE-NN) model, in accordance with the present disclosure. The DKE-NN model as shown in FIG. 6A comprises an input layer, two hidden layers, and an output layer. The activation functions for the various layers may be selected using domain specific knowledge. Although described with reference to the first DKE-NN model as shown in FIG. 6A, the operation of the other DKE-NN models may be similarly explained.

The input layer of the first DKE-NN model may comprise L₀=2Q number of neurons, where Q represents the number of pilot sub-carriers. [Real(Y), Imag(Y)] may therefore represent a 2Q×1 input data vector that is applied at the input layer from the training samples, as discussed herein.

The first and the second hidden layers are both dense (fully connected), having L₁ and L₂ number of neurons, respectively. Each hidden layer uses a ReLu activation function.

The output layer is bifurcated into two tensors. The first output tensor is a dense layer with SoftMax activation function that estimates any suitable statistical channel parameter for which the DKE-NN is trained. This may include a PDP estimate ρₙₙ (when the NN is trained using the generated training samples Y) or an AS estimate αₙₙ (when the NN is trained using the CSI Ĥ), each being a N_{b}×1 vector. The second output tensor is another dense layer with a Sigmoid activation function that computes another N_{b}×1 vector νₙₙ corresponding to the reciprocal of Lagrange multipliers

$$\frac{1}{1 + abs ( {μ}^{*} - λ )}$$

for the particular statistical channel parameter, as indicated in the generated training data as noted above with respect to FIG. 2. It is noted that a single set of Lagrange multipliers μ*and λ are shown in the Figures for brevity, with each corresponding to a respective set of training data. To provide some illustrative scenarios, when the training architecture as shown in FIGS. 6A-6C is trained to estimate statistical parameters such as PDP, then the Lagrange multipliers as shown may correspond to the PDP Lagrange multipliers as discussed above. However, when the training architecture as shown in FIGS. 6A-6C is trained to estimate statistical parameters such as the AS, then the Lagrange multipliers as shown may correspond to the AS Lagrange multipliers as discussed above.

Turning now to FIG. 6A, the backpropagation path comprises separate loss functions for each output. That is, the output of the first tensor (for the first stage) comprises an estimate of the PDP estimate per each quantized training sample, i.e. in the quantized delay domain. This estimate is thus “driven” during training to represent the corresponding quantized PDP estimate ρ_{MLE} from the training data via a comparison using categorical cross entropy to provide a loss value l₁, as shown in FIG. 6A. This may be the case when the training samples Y are provided as an input to the DKE-NN architecture 600. Alternatively (i.e. during a second stage), the output of the first tensor comprises the maximum likelihood estimate α_{MLE} of the power received in the quantized angle of arrival domain for AoA estimation. In either case, the output of the second tensor comprises an estimate of the reciprocal of Lagrangian multipliers per each quantized training sample. This estimate is thus “driven” during training to represent the corresponding value of

$$\frac{1}{1 + abs ( {μ}^{*} - λ )}$$

estimated from the training data via a comparison with a mean squared error function to provide a loss value l₂, as shown in FIG. 6A.

Thus, the PDP estimate output ρₙₙ (in the first stage) or αₙₙ (in the second stage) uses categorical cross-entropy, while the output Lagrange multipliers νₙₙ use a mean squared error function. In other words, the DKE-NN model as shown in FIG. 6A is trained to reproduce the same type of data as the training data discussed above with respect to FIG. 2 by imitating the MLE processes by which the training data was originally generated. The use of the Lagrange multipliers as part of the training process, which were generated as part of the training data as noted above, is particularly advantageous. However, the auxiliary output of νₙₙ results in an additional loss value, and thus each of these loss values need to be combined in the backpropagation path. To do so, the gradients of the two loss values is illustrated in FIG. 6A as part of the backpropagation path, which represents a linear combination of the loss functions that may be weighted differently by α₁≥0 and α₂≥0. For the present non-limiting and illustrative scenario, α₁=α₂=0.5, however, these weights may be modified and/or comprise different values than one another based upon the particular application.

FIG. 6B illustrates a training architecture for a second domain knowledge enhanced neural network (DKE-NN) model, in accordance with the present disclosure. The DKE-NN model as shown in FIG. 6B may operate in a similar manner as the DKE-NN model as shown and described above with respect to FIG. 6A, and may use the same training data at different stages to estimate statistical channel parameters such as ρₙₙ and αₙₙ, as well as to estimate the corresponding Lagrange multipliers. The DKE-NN model as shown in FIG. 6B also uses a bifurcated output layer, with a Sigmoid activation function for the estimation of the Lagrange multipliers and a SoftMax activation function for the estimation of the statistical channel parameters ρₙₙ or αₙₙ, as the case may be. The Sigmoid activation function in this case further receives, as input, the output of the SoftMax activation function, i.e. ρₙₙ or αₙₙ. In some scenarios, this architecture may provide a more accurate estimate of PDP/AS compared to that shown in FIG. 6A.

FIG. 6C illustrates a training architecture for a third domain knowledge enhanced neural network (DKE-NN) model, in accordance with the present disclosure. The DKE-NN model as shown in FIG. 6C may operate in a similar manner as the DKE-NN model as shown and described above with respect to FIG. 6B, and may use the same training data at different stages to estimate statistical channel parameters such as ρₙₙ and αₙₙ, as well as to estimate the corresponding Lagrange multipliers. The DKE-NN model as shown in FIG. 6C also uses a bifurcated output layer, with the Sigmoid activation function being implemented for the estimation of the Lagrange multipliers and the SoftMax activation function for the estimation of the statistical channel parameters ρₙₙ or αₙₙ, as the case may be. However, in this scenario the SoftMax activation function further receives, as input, the output of the Sigmoid activation function, i.e. νₙₙ. In other scenarios, where Lagrange are easier to estimate, this architecture may be more advantageous as it provides more accuracy compared to those in FIGS. 6A and 6B.

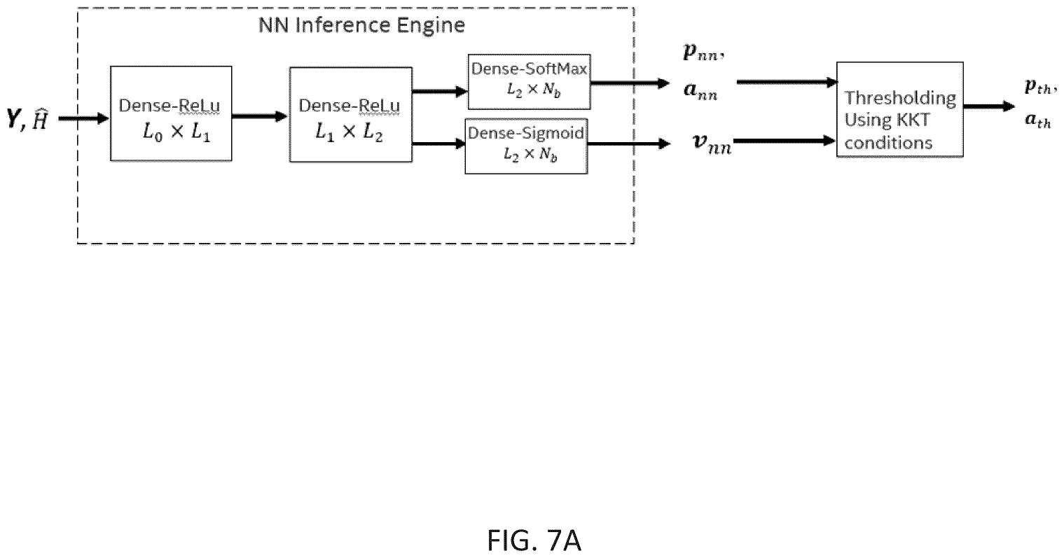

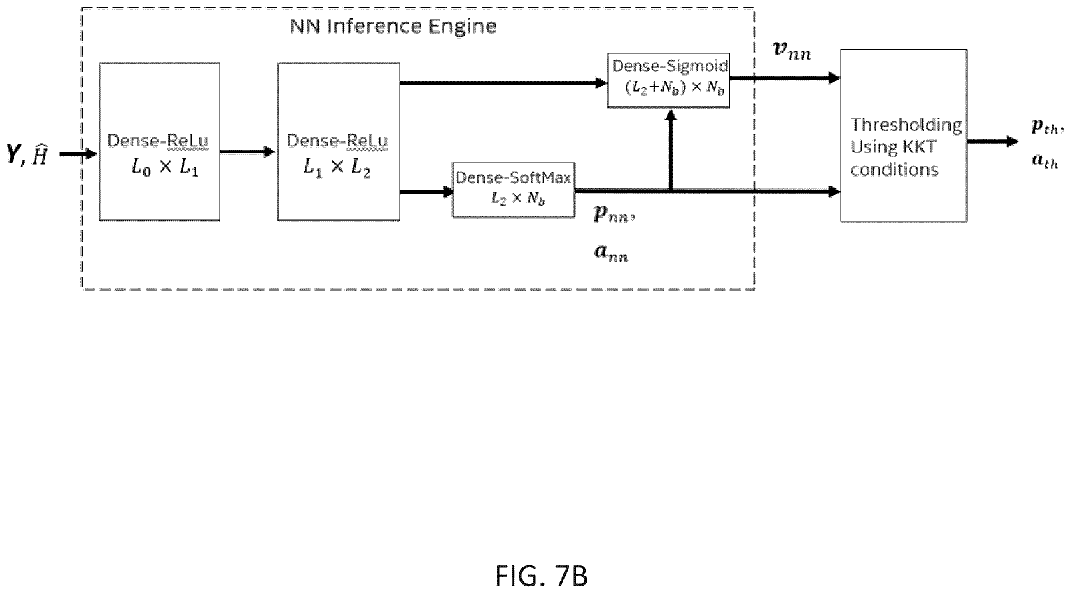

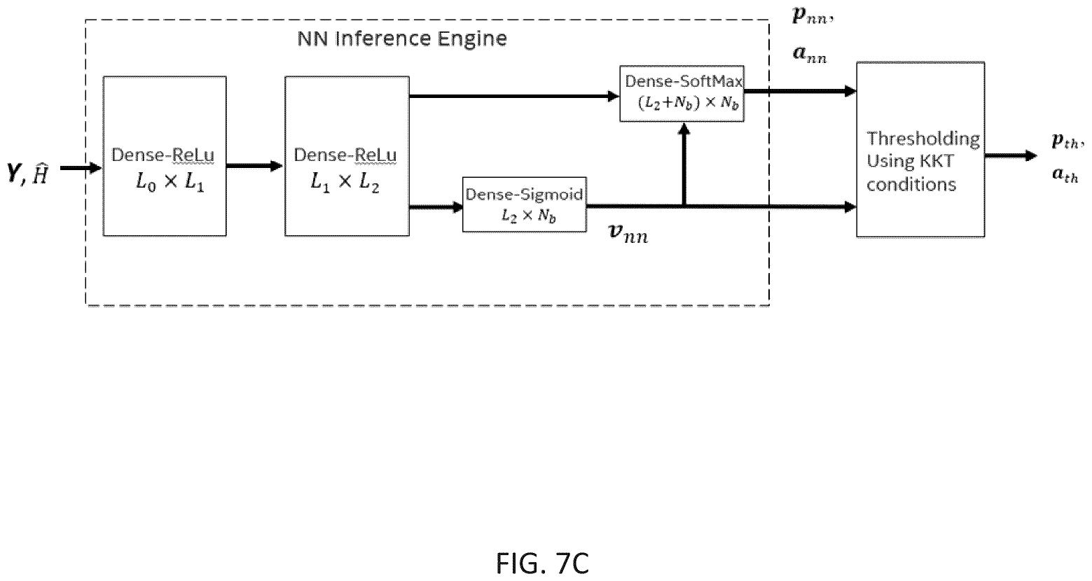

Thus, each of FIGS. 6A-6C illustrates a DKE-NN training architecture that is implemented to train a DKE-NN model offline using various sets of training data, as discussed herein. Each type of DKE-NN model may then be deployed in a suitable computing device to perform the functions for which each DKE-NN model was trained with respect to newly received wireless signals. This is shown in further detail with respect to the trained DKE-NN architectures as shown in FIGS. 7A-7C. The trained DKE-NN architectures as shown in FIGS. 7A-7C, i.e. the NN interference engines as shown, may thus correspond to the same architectures as the DKE-NN training models as shown and described with respect to FIGS. 6A-6C, respectively.

Regardless of the particular DKE-NN model that is implemented, once training is complete, the weights and biases of the trained DKE-NN model may then be used to perform online inference of the statistical channel parameters for which the DKE-NN model has been trained to estimate, such as the PDP and AS for a received signal as discussed herein. This inference is shown in FIGS. 7A-7C as part of a trained NN inference engine, which again may have the same architecture as the corresponding training architecture discussed with respect to FIGS. 6A-6C. In addition, the trained DKE-NN generates estimates of Lagrange multipliers, which may serve as thresholds under Karush Kuhn Tucker conditions to further refine the initial statistical channel parameter estimates. Appendix C provides additional details regarding the online thresholding process.

Thus, the trained DKE-NN models (i.e. the NN inference engines) as shown in FIGS. 7A-7C may likewise operate in separate stages to compute the statistical channel parameters and CSI identified with the propagation of a wirelessly received signal, which may be used for beamforming as further discussed herein. To do so, during the first stage, the trained DKE-NN model estimates one or more statistical channel parameters from observations of a received signal Y, such as the PDP of the received signal, which is represented in FIGS. 7A-7C as ρₙₙ. The estimated channel parameters (PDP in this case), are then used to estimate the CSI of the channel. The CSI computation is not shown in the Figures, but may be performed in any suitable manner, including the use of known techniques, from the estimated statistical channel parameters such as PDP. This may include, in a non-limiting and illustrative scenario, inferring TO from the estimated PDP, and applying TO correction to Y prior to CSI estimation. In a non-limiting and illustrative scenario, the trained DKE-NN models may estimate the CSI per antenna by first computing the estimated power delay profile (PDP) per antenna of the antenna array, and then computing an average of the estimated PDP per antenna, which is represented as ρₙₙ, and which may be further refined to ρₜₕ. A Wiener filter may then be computed such that the channel per antenna is estimated, resulting in the estimated CSI Ĥ as shown in Eqn. 3. Alternatively, the average PDP across each of the antennas may not be performed, and a separate Wiener filter may instead be computed from the estimated PDP per antenna.

Again, the trained DKE-NN models as shown in FIGS. 7A-7C are configured to estimate Lagrange multipliers along with the statistical channel parameter ρₙₙ. Thus, and as shown in FIGS. 7A-7C, the CSI of the channel may be computed from ρₙₙ or the refined PDP value ρₜₕ. This refined PDP value ρₜₕ, as shown in FIGS. 7A-7C, may correspond to a PDP value that meets the Karush Kuhn Tucker (KKT) conditions with respect to the estimated Lagrange multipliers. That is, the PDP value ρₜₕ may be determined by applying KKT conditions to the initially estimated statistical channel parameter ρₙₙ using the corresponding Lagrange multipliers, as described in further detail in Appendix C.

Once the CSI is estimated in this manner, the angular spectrum (AS) may be estimated as part of a second stage inference, which again represents the distribution of received power at different angles of arrival with respect to the antenna array. This estimation may be performed by estimating an AS per sub-carrier identified with the received signal, and then averaging the covariance matrix over each one of the sub-carriers. Finally, the AS is then estimated from the averaged covariance matrix to obtain a “final” AS estimation that is used for beamforming weight computations. The CSI and the AS may thus be used to perform multiple-input multiple-output (MIMO) antenna beamforming for the transmission and/or reception of signals to the device(s) from which the wireless signals were received.

To do so, the trained DKE-NN models as shown in FIGS. 7A-7C are configured to estimate additional statistical channel parameters in the second stage using the CSI Ĥ of the wireless channel as inputs. The trained DKE-NN models as shown in FIGS. 7A-7C may thus estimate an initial statistical channel parameter αₙₙ, which represents the initial estimated AS of the received signal, as well as the estimated corresponding Lagrange multipliers. The refined statistical channel parameter αₜₕ may likewise be determined by applying the KKT conditions to the initially estimated statistical channel parameter αₙₙ using the corresponding Lagrange multipliers, as described in further detail in Appendix C with respect to the estimated statistical channel parameter ρₙₙ. Either of the initial statistical channel parameter αₙₙ or the corresponding refined statistical channel parameter αₜₕ may thus be identified with the “final” AS as noted above, which may be utilized for beamforming weight computations using any suitable techniques, including known techniques.

### C. Simulation Results

Numerical results for a simulation that was performed using the first DKE-NN model as shown in FIG. 6A and operating at inference in accordance with the DKE-NN architecture as shown in FIG. 7A is provided in further detail below. All parameters for this simulation are listed in Table 1 below.

TABLE 1
Signal configuration

| Parameters | Value | |
|---|---|---|
| Sub-carrier spacing, Δf | 15 | KHz |
| Cyclic prefix (CP) duration | 4.6875 | microsec |

| | |
|---|---|
| Number of resource blocks, N_{RB} | 16 |
| Pilot spacing, d (in number of sub-carriers) | 4 |
| Number of pilot sub-carriers | 48 |
| Denoising block length for | 8 |
| pilot sub-carriers | |
| Evaluation 3GPP channel models | TDLA |

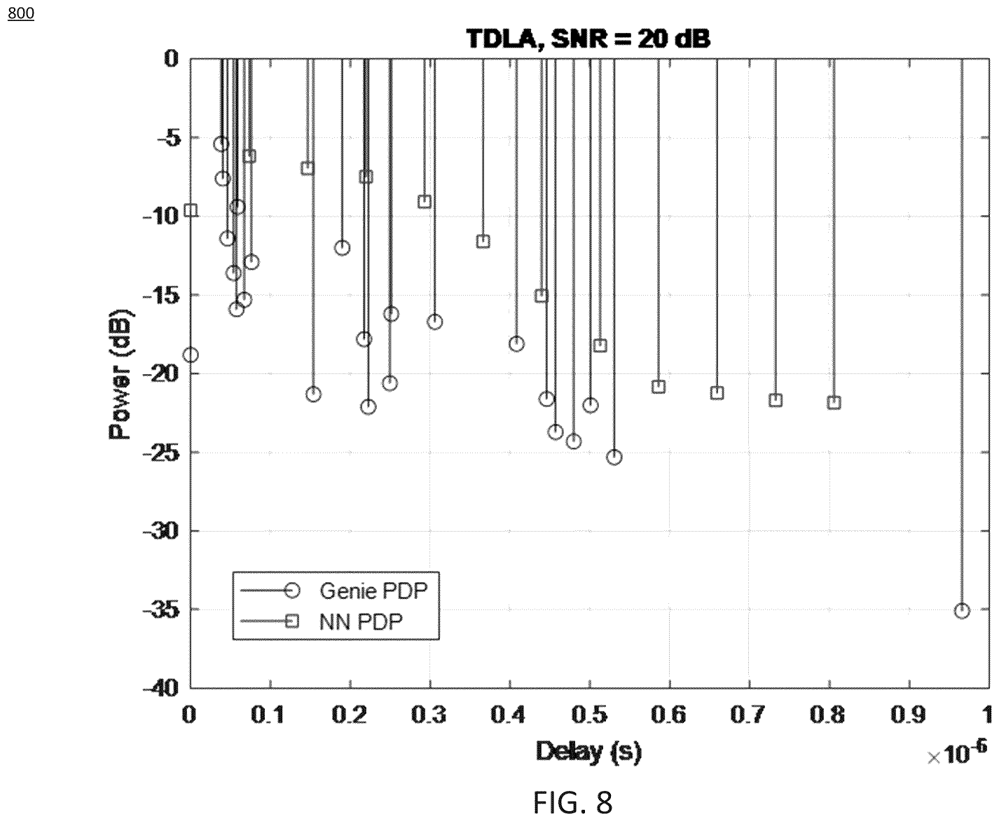

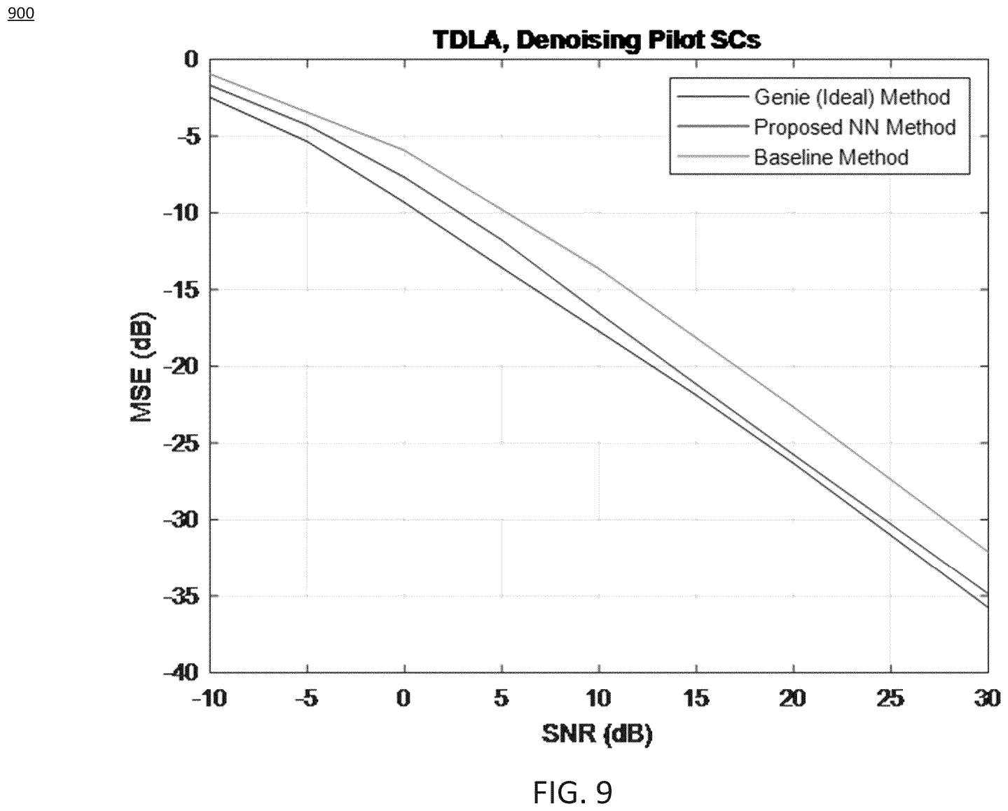

First, mean squared error (MSE) performance is provided for channel estimation using the first DKE-NN inference engine (See FIG. 7A). The performance is compared with a conventional Genie PDP and baseline method, which assumes a rectangular PDP of the length of cyclic prefix. FIG. 8 illustrates a true (genie) PDP of a 3GPP TDLA channel model along with the PDP estimate obtained from the DKE-NN inference engine of FIG. 7A. The MSE performance is shown in FIG. 9.

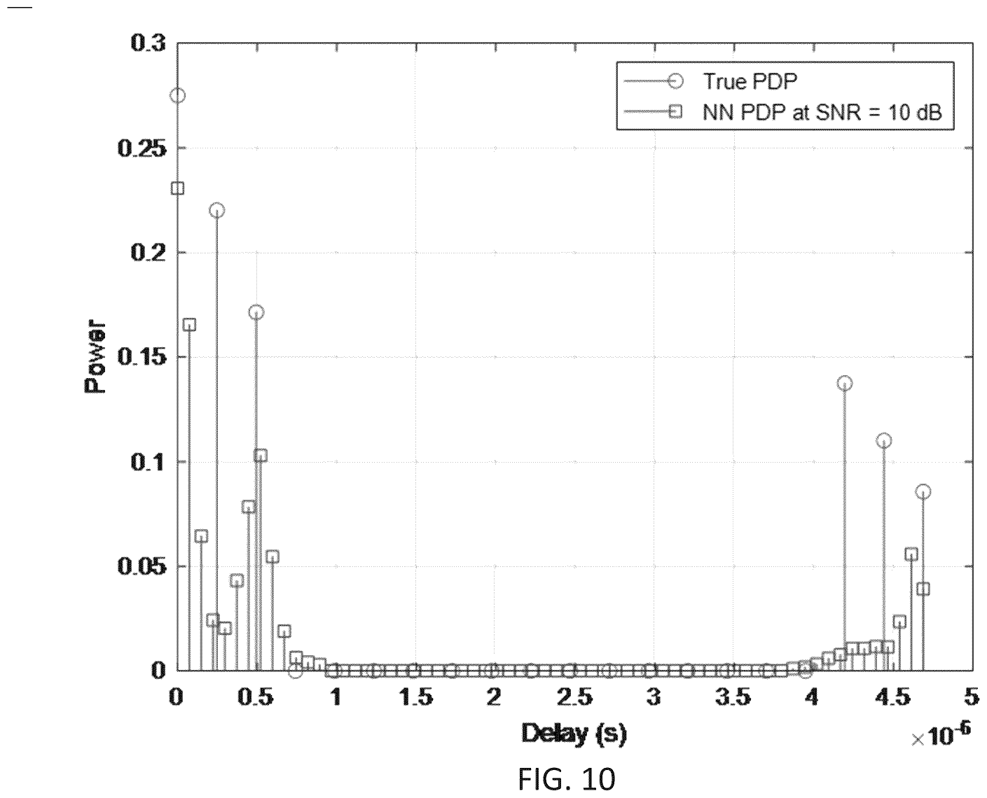

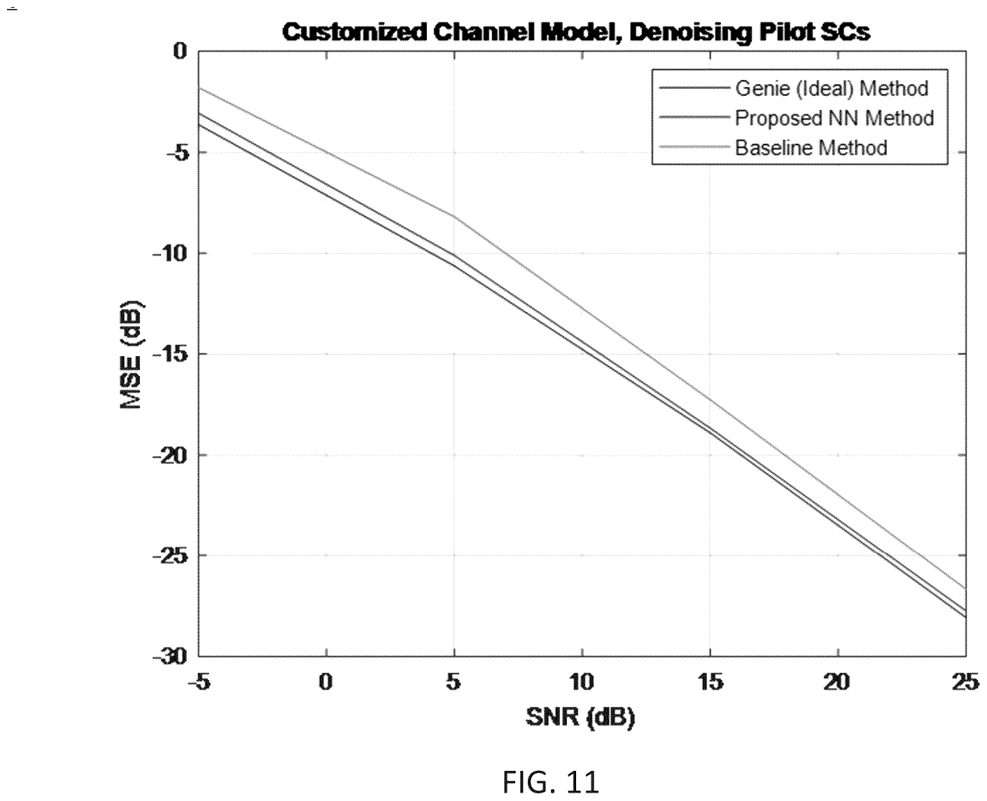

Next, in FIGS. 10 and 11, performance of the DKE-NN as shown in FIG. 7A is illustrated in a two-cluster channel model representing signal propagation in a rural environment with a strong line of sight component and strong echoes coming from a reflection from a far object like mountains. FIG. 10 illustrates the PDP estimate for this customized channel model computed using the DKE-NN inference engine as shown in FIG. 7A. FIG. 11 illustrates denoising performance of the DKE-NN as shown in FIG. 7A in a two cluster channel model.

In the next set of simulation results, the AoA estimation performance of a DKE-NN is demonstrated using a uniform linear array channel model as described in the table below. The azimuth angular space (−π/2, π/2) has been partitioned into 180 equal parts with a resolution of Δ_{φ}=1⁰. The signal configuration and channel parameters are also provided below in Tables 2 and 3, respectively.

TABLE 2
Signal configuration

| Parameter | Value | |
|---|---|---|
| Sub-carrier spacing, Δf | 30 | KHz |
| Cyclic prefix (CP) duration | 2.3438 | microsec |

| | |
|---|---|
| Number of resource blocks, N_{RB} | 272 |
| Pilot spacing, d (in number of sub-carriers) | 2 |
| Channel Estimation | Least Square |
| Number of receive antennas | 64 |

TABLE 3
Channel parameters for AoA Inference

| Parameter | Value |
|---|---|
| Number of clusters | 4 |
| Number of channel taps per cluster | 10 |
| Center Azimuth AoA of each cluster | 15⁰, 75⁰, −15⁰, −50⁰ |
| Angular spread of each cluster | 5⁰ |
| Center delay of each cluster | Uniformly distributed in [0, CP] |
| Delay spread each cluster | ±10% of center delay |
| | (with wrap around at 0 and CP) |
| Channel tap gain | Complex Normal random variable |

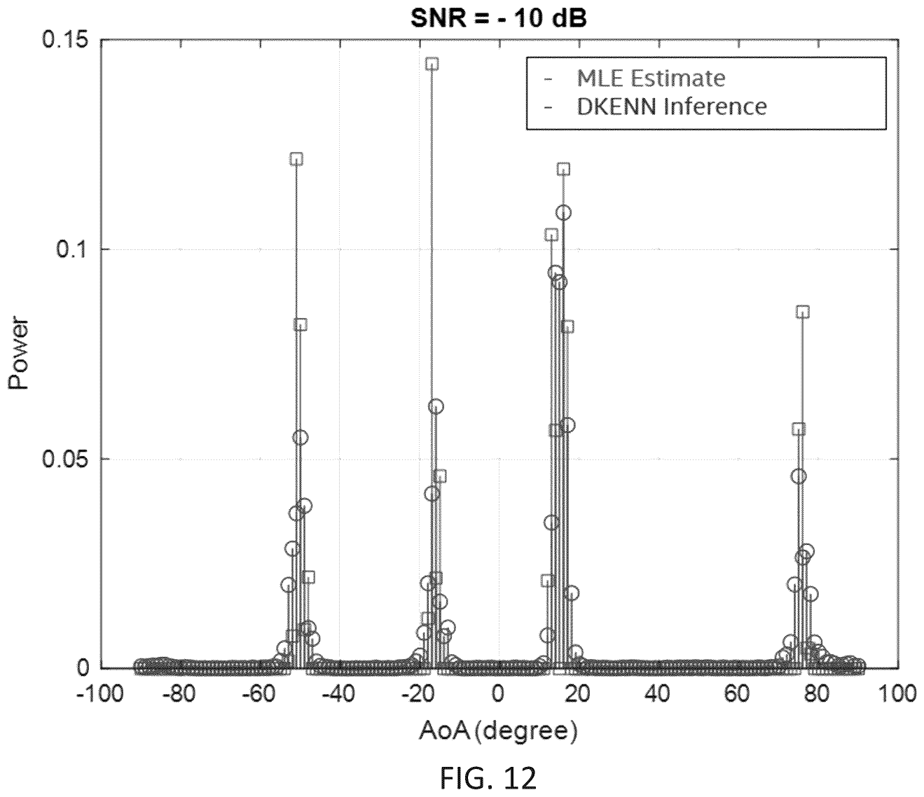

Performance was evaluated at 10 dB SNR per sub-carrier per receive antenna, and the results are shown in FIG. 12. The DKE-NN inference engine as shown in FIG. 7A distinctly estimates each of the four clusters. Furthermore, the DKE-NN inference is a near-maximum likelihood estimate of the AoA (as it has been trained).

### D. A Computing Device

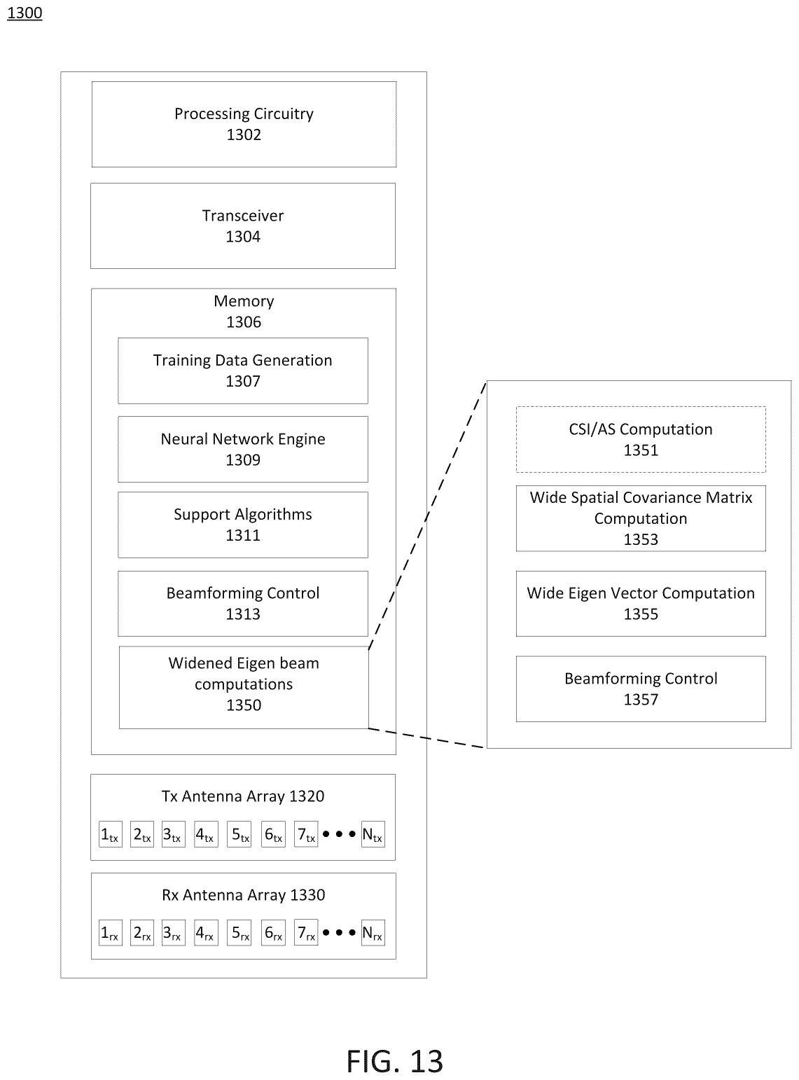

FIG. 13 illustrates a computing device, in accordance with the present disclosure. The computing device 1300 may be implemented as a standalone device or a component that is used for any suitable type of wireless communication application. Thus, the computing device 1300 may alternatively be referred to as a communication device. For instance, the computing device 1300 may be implemented as part of or comprise a base station or a UE as discussed above with respect to FIG. 1, or as any other suitable device that wirelessly communicates with other devices. The computing device 1300 may include one or more components configured to transmit and/or receive wireless signals. The computing device 1300 may perform any of the functions as discussed herein with respect to the generation of training data, training a neural network, performing inference via the trained neural networks, etc. Thus, the computing device 1300 may implement the various techniques as discussed herein to estimate the statistical channel parameters and the CSI with respect to signals that have been received via a wireless channel, and to perform beamforming to transmit and/or receive signals using the estimated statistical channel parameters and CSI, as discussed herein.

To do so, the computing device 1300 may include processing circuitry 1302, a transceiver 1304, a memory 1306, a transmit antenna array 1320 including any suitable number Ntx of transmit antennas, and a receive antenna array 1330 including any suitable number Nrx or receive antennas. The components shown in FIG. 13 are provided for ease of explanation, and the computing device 1300 may implement additional, less, or alternative components as those shown in FIG. 13. Thus, in various non-limiting and illustrative scenarios, the computing device 1300 may include one or more power sources, display interfaces, peripheral devices, ports, etc. Further, although the transmit and receive antenna arrays 1320, 1330 are illustrated in FIG. 13 as separate arrays, these may be combined into a single antenna array that may be controlled by the computing device 1300 to receive and/or transmit signals at different times.

The processing circuitry 1302 may be configured as any suitable number and/or type of computer processors, processing circuitry, hardware circuitry, etc., which may function to control the computing device 1300 and/or other components of the computing device 1300. The processing circuitry 1302 may be identified with one or more processors (or suitable portions thereof) implemented by the computing device 1300. The processing circuitry 1302 may be identified with one or more processors such as a central processing unit (CPU), a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processing circuitry 1302 may be configured to carry out instructions to perform arithmetical, logical, and/or input/output (I/O) operations, and/or to control the operation of one or more components of computing device 1300 to perform various functions as described herein. The processing circuitry 1320 may include one or more microprocessor cores, memory registers, buffers, clocks, etc., and may generate electronic control signals associated with the components of the computing device 1300 to control and/or modify the operation of these components. The processing circuitry 1302 may communicate with and/or control functions associated with the transceiver 1304, the memory 1306, the transmit antennas 1320, and/or the receive antennas 1330.

The transceiver 1304 may be implemented as any suitable number and/or type of components configured to transmit and/or receive data (such as data packets) and/or wireless signals in accordance with any suitable number and/or type of communication protocols. The transceiver 1304 may include any suitable type of components to facilitate this functionality, including components associated with known transceiver, transmitter, and/or receiver operation, configurations, and implementations. Although depicted in FIG. 13 as a single transceiver, the transceiver 1304 may include any suitable number of transceivers, transmitters, receivers, or combinations of these that may be integrated into a single transceiver or as multiple transceivers or transceiver modules. The transceiver 1304 may include components typically identified with an RF front end and include antennas, ports, power amplifiers (PAs), RF filters, mixers, local oscillators (LOs), low noise amplifiers (LNAs), upconverters, downconverters, channel tuners, etc. Thus, the transceiver 1304 may be configured as any suitable number and/or type of components configured to facilitate receiving and/or transmitting data and/or signals in accordance with one or more communication protocols. The transceiver 1304 may be implemented as any suitable number and/or type of components to support wireless communications such as analog-to-digital converters (ADCs), digital to analog converters, intermediate frequency (IF) amplifiers and/or filters, modulators, demodulators, baseband processors, etc. The data received via the transceiver 1304, data provided to the transceiver 1304 for transmission, and/or data used in conjunction with the transmission and/or reception of data via the transceiver 1304 (such as beamforming weights) may be processed via the processing circuitry 1302, as discussed herein.

The memory 1306 is configured to store data and/or instructions such that, when the instructions are executed by the processing circuitry 1302, cause the computing device 1300 to perform any of the various functions as described herein. The memory 1306 may be implemented as any suitable volatile and/or non-volatile memory, including read-only memory (ROM), random access memory (RAM), flash memory, a magnetic storage media, an optical disc, erasable programmable read only memory (EPROM), programmable read only memory (PROM), etc. The memory 1306 may be non-removable, removable, or a combination of both. The memory 1306 may be implemented as a non-transitory computer readable medium storing one or more executable instructions such as, for example, logic, algorithms, code, etc.

As further discussed below, the instructions, logic, code, etc., stored in the memory 1306 are represented by the various modules as shown, which may enable the functionality disclosed herein to be functionally realized. Alternatively, the modules as shown in FIG. 13 that are associated with the memory 1306 may include instructions and/or code to facilitate control and/or monitor the operation of hardware components implemented via the computing device 1300. In other words, the modules shown in FIG. 13 are provided for ease of explanation regarding the functional association between hardware and software components. Thus, the processing circuitry 1302 may execute the instructions stored in these respective modules in conjunction with one or more hardware components to perform any of the various functions as discussed herein. Although illustrated as separate modules, this is for ease of explanation, and it will be understood that the memory 1306 may store computer-readable instructions in any suitable format as an executable set of data instructions such that any of the functionality as described herein may be performed via execution of the instructions stored in the memory 1306.

The executable instructions stored in the training data generation module 1307 may facilitate, in conjunction with execution via the processing circuitry 1302, the computing device 1300 generating any of the training data as discussed herein, which may then be used to perform neural network model training. This may include the generation of training samples, the CSI, and any of the statistical channel parameters that are derived from the training samples and/or the CSI. This may include, in a non-limiting and illustrative scenario, any of the training data as discussed herein with respect to FIG. 2. Thus, the training data generation module 1307 may facilitate, in conjunction with execution of instructions via the processing circuitry 1302, the computing device 1300 realizing the entirety or a portion of the architecture 200.

The neural network engine 1309 may represent the functionality as discussed herein with reference to training any suitable type of neural network using the training data. Thus, the neural network engine 1309 may facilitate, in conjunction with execution of instructions via the processing circuitry 1302, the computing device 1300 realizing the entirety or a portion of the architecture of any suitable type of neural network, such as any of the DKE-NN model architectures as discussed herein with respect to FIGS. 6A-6C and 7A-7C. The neural network engine 1309 may thus represent the functionality associated with offline training of the DKE-NN models in various stages using the generated training data as shown and discussed herein with respect to FIGS. 6A-6C. The neural network engine 1309 may further facilitate the functionality associated with the online use of the DKE-NN models in various stages based upon observations as wireless signals are received, as shown and discussed herein with respect to FIGS. 7A-7C. Again, the trained DKE-NNs may be implemented online to perform the various inferences, such as the estimation of the CSI and/or any of the statistical channel parameters, as discussed herein.

The support algorithms 1311 may represent the functionality described herein with reference to performing any suitable algorithms that may support or otherwise work in conjunction with the generation of training data, the inferences performed via the trained neural networks, etc. Thus, in some non-limiting and illustrative scenarios, the support algorithms 1311 may facilitate, in conjunction with execution of instructions via the processing circuitry 1302, the computing device 1300 performing the quantization of the statistical channel parameters using various wireless propagation models as discussed in further detail in Appendix A, performing MLE of the statistical channel parameters and/or executing the Maximum Likelihood Estimator algorithm as discussed in further detail in Appendix B, performing the thresholding algorithm for post-processing the DKE-NN output as discussed in further detail in Appendix C, etc.

The beamforming control module 1313 may represent the functionality described herein with reference to performing any suitable type of beamforming using the estimates provided by the trained DKE-NN models as discussed herein. Thus, in some non-limiting and illustrative scenarios, the beamforming control module 1313 may facilitate, in conjunction with execution of instructions via the processing circuitry 1302, the computing device 1300 performing beamforming by applying weights to the antennas in the transmit antenna array 1320 and/or the receive antenna array 1330. This beamforming may be performed utilizing the CSI and AS estimates output via the trained DKE-NN model, such as any of those discussed herein the respect to FIGS. 7A-7C. The beamforming may utilize the output of the KTT conditions as discussed herein, such that the refined statistical channel parameters (i.e. those meeting the KTT conditions) are used for this purpose. The beamforming may comprise any suitable beamforming techniques using this information, including known techniques. Once the beamforming has been performed, the computing device 1300 may transmit signals via the transmit antenna array 1320 to the wireless device from which the signals used to compute the beamforming pattern were received. Additionally or alternatively, the computing device 1300 may receive subsequent signals via the receive antenna array 1330 from the wireless device from which the signals used to compute the beamforming pattern were received.

### E. A Process Flow

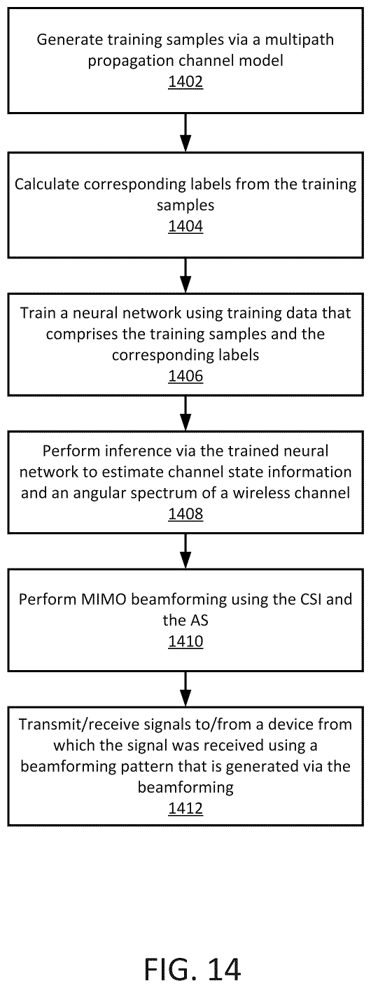

FIG. 14 illustrates a process flow, in accordance with the present disclosure. With reference to FIG. 14, the flow 1400 may be a computer-implemented method executed by and/or otherwise associated with one or more processors (processing circuitry) and/or storage devices. These processors and/or storage devices may be associated with one or more computing components identified with any suitable computing device (such as the base station 102, the UEs 104, the computing device 1300, etc.). The one or more processors identified with one or more of the computing components as discussed herein may execute instructions stored on any suitable computer-readable storage medium, which may or may not be shown in the Figures. The flow 1400 may include alternate or additional steps that are not shown in FIG. 14 for purposes of brevity, and may be performed in a different order than the steps shown in FIG. 14.

Flow 1400 may begin when one or more processors generate (block 1402) training samples. This may include generating the training samples via a multipath propagation channel model, as discussed herein, such as via the evaluation of Equation 1.

Flow 1400 may include one or more processors calculating (block 1404) corresponding labels. These labels may include any of the statistical channel parameters as discussed herein, such as a MLE of power received in the quantized delay domain, a MLE of power received in the quantized angle of arrival domain, corresponding Lagrange multipliers, etc.

Flow 1400 may include one or more processors training (block 1406) a neural network using training data. The training data may comprise the training samples and the set of corresponding labels. This may include training any of the DKE-NN models as shown and discussed herein with respect to FIGS. 6A-6C.

Flow 1400 may include one or more processors performing (block 1408) inference via the trained NN to estimate any suitable number and/or type of statistical channel parameters and/or the CSI. This may include estimating the angular spectrum (AS) of a wireless channel identified with the propagation of a received signal. The inference may be performed via any of the DKE-NN models as shown and discussed herein with respect to FIGS. 7A-7C.

Flow 1400 may include one or more processors performing (block 1410) beamforming using the estimated CSI and the estimated AS that were provided via the trained NN. This may include performing any suitable type or beamforming to compute and apply the weights to the antennas of the applicable device.

Flow 1400 may include one or more processors performing (block 1412) data communications via an antenna array in accordance with the beamforming pattern formed via application of the computed weights. This may include the transmission of signals via the transmit antenna array 1320 to the wireless device from which the signals were received and used to compute the beamforming pattern. Additionally or alternatively, this may include receiving subsequent signals via the receive antenna array 1330 from the wireless device from which the signals were received and used to compute the beamforming pattern.

### Section II—Performing Beamforming Using Widened Eigen Beams

Beamforming is a wireless MIMO technology for transmitting or receiving signals in a particular spatial direction. In this disclosure, the term “beamforming” may include reducing signal dimensions by combining multiple signals from multiple antennas into a smaller number of signals. In addition, the term “beamforming” may also include port reduction or the compression of multiple antennas.

In any event, and as noted in Section I above, to perform beamforming a receiver or transmitter requires an accurate measurement of channel state information (CSI), which again includes an instantaneous impulse response of a channel or statistics of a channel. Referring back to FIG. 1, typically in uplink cellular systems such as 3GPP long-term evolution (LTE) and new radio (NR), CSI is measured at the base station 102 using sounding reference symbols (SRS), which are periodically transmitted via the UEs 104, and from which the base station 102 computes the beamforming weights used for compression and transmit beamforming. The same beamforming weights are applied on all data symbols until the next SRS is received. However, as the periodicity of SRS transmissions may be up to 40 milliseconds due to the time-varying nature of wireless channels, the beamforming weights may quickly become severely outdated, resulting in a significant loss in spectral efficiency.

Previous solutions that address this issue include measuring the CSI from one or more SRS symbols that have been received in the past, and then computing a sample covariance matrix associated with the channel. The sample covariance matrix in this context refers to a covariance matrix that is computed from the empirical mean of the outer product of received samples. Singular vectors of the sample covariance matrix are then used as beamforming weights. However, a major disadvantage of such conventional solutions is that the beamforming weights are dominated by the measured CSI. Thus, whenever the wireless channel changes, the beamforming weights become outdated, resulting in a significant loss in spectral efficiency. This loss is even more exacerbated in non-stationary wireless channels having a time-varying angle of arrival (AoA).

This Section addresses this issue by providing an eigen beamforming algorithm that is robust to the age of CSI in both the second order stationary and non-stationary fading process. As further discussed below, this is accomplished by performing eigenvector widening as a series of steps. The first of these includes the estimation of an angular spectrum (AS) using a CSI, which may be measured from an aged SRS symbol. Alternatively, the CSI and/or AS may be estimated using the techniques described above in Section I. Once the AS is estimated, the eigenvector beams are widened by injecting power in the vicinity of estimated main beam locations (i.e. the estimated eigenvector beam locations) within the AS to compute a widened spatial covariance matrix, from which widened eigenvectors are computed. Finally, eigen beamforming is performed using the widened eigenvectors.

Conventionally, beamforming in a wireless MIMO channel is performed using codebooks such as discrete Fourier transform (DFT)-based codebooks or a wider DFT codebook. Other conventional beamforming techniques utilize the eigenvectors of an estimated covariance matrix. The techniques described in this Section differ from these conventional approaches by widening the eigenvectors used for eigen beamforming.

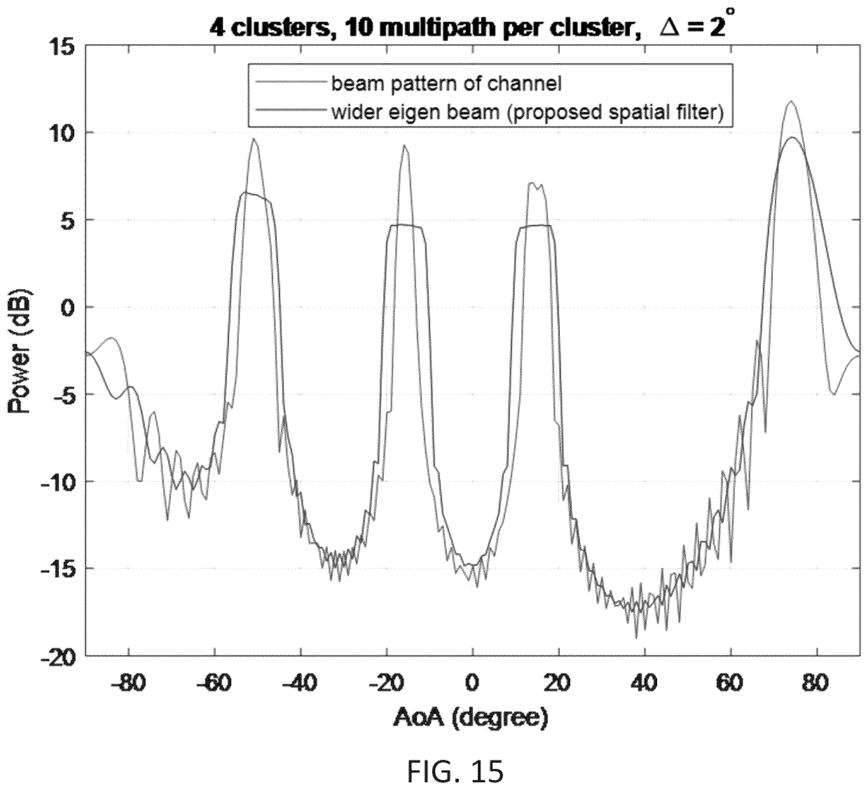

That is, unlike the DFT-based codebook approach, each eigenvector beam has multiple fingers, and the beamforming techniques described in this Section describe techniques to jointly widen each finger of the eigenvector beam. As an non-limiting and illustrative scenario, FIG. 15 shows four fingers of an eigenvector beam (in red color, which are narrower), as well as the wider eigenvector beam (in blue color, which are wider) in which each of the “fingers” has been jointly widened by 2 degrees. These wide multi-fingered beams function as spatial filters, which are robust to variations in the AoAs caused by mobility. The widening of the eigen beams of a MIMO channel to perform beamforming may provide, in some illustrative and non-limiting scenarios, a 5 dB to 35 dB gain over conventional algorithms. It is noted that the terms “eigen beam” and “eigenvector beam” are used herein interchangeably and are synonymous. Likewise, the terms “wide eigen beam” and “wide eigenvector beam” are also used herein interchangeably and are also synonymous.

### A. Eigen Beamforming Algorithm Implementation

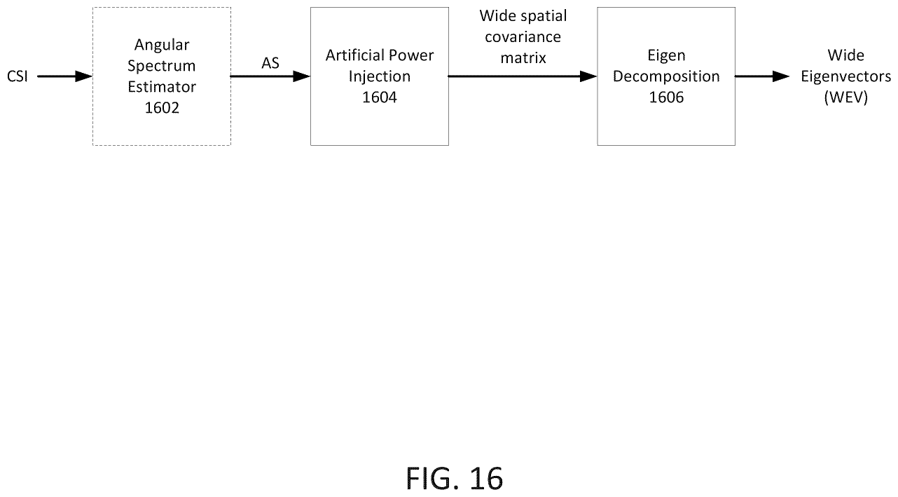

FIG. 16 illustrates a block diagram identified with the generation of wide eigenvector beamforming weights, in accordance with the present disclosure. FIG. 16 illustrates how the flow of data may be implemented to generate the wide eigenvectors, which may in turn be implemented to provide beamforming, as discussed in further detail herein. As shown in FIG. 16, the architecture 1600 comprises an angular spectrum (AS) estimator block 1602, an artificial power injection block 1604, and an eigen decomposition block 1606. Each of the blocks 1602, 1604, 1606 may be implemented as any suitable type of hardware circuitry, executable software, or combinations of these to perform their respective functions. The architecture 1600 as shown in FIG. 16 may comprise part of the same computing device that implements the neural network architectures as discussed above in Section I. Alternatively, the architecture 1600 may be identified with a separate computing device.

With continued reference to FIG. 16, the AS estimator block 1602 receives channel state information (CSI), which may be measured in various ways. In one non-limiting and illustrative scenario, the CSI may be identified with the estimated CSI that is determined via any of the trained neural network models described herein, such as those discussed with respect to FIGS. 7A-7C. Thus, the CSI may be estimated online at inference, and provided to the AS estimator block 1602. Alternatively, the CSI may be measured via the computing device in which the architecture 1600 is implemented using a received sounding reference signal (SRS) in accordance with any suitable techniques, including known techniques. Regardless of how the CSI is measured, the CSI may be provided to the AS estimator block 1602 as the first stage in the beamforming process.

The AS estimator block 1602 is configured to compute an angular spectrum from the CSI, which again is identified with a wirelessly received signal. As noted above with respect to Section I, the angular spectrum may represent a distribution of received power at different angles of arrival with respect to an antenna array. The AS estimator block 1602 is configured to compute the angular spectrum from the CSI using any suitable techniques. In one illustrative and non-limiting scenario, the AS estimator block 1602 is configured to compute the estimated AS from the CSI using known techniques, which may include those described in Appendix D and/or the use of an aged Sounding Reference Symbol (SRS), as discussed herein. Thus, in such scenarios, although the beamforming weights may still quickly become outdated, the widening of the eigen beams provides for a more robust performance despite this issue.

However, in other illustrative and non-limiting scenarios, the AS estimator block 1602 may compute the estimated AS from the CSI using alternative techniques, which may comprise the implementation of a beam pattern-based AS estimation or an MLE-based AS estimation, each being described in further detail below. In either case, the angular space (−π/2, π/2) is partitioned into any suitable N_{b} number bins, where the angular width of each angular bin is defined as

$$Δ = \frac{π}{{N}_{b}} .$$

It is noted that the angular space and number of bins is provided herein for ease of explanation and in a non-limiting and illustrative manner, and alternative values may be selected for the AS estimation that is performed via the AS estimator block 1602.

In a first non-limiting and illustrative scenario, the AS estimator block 1602 may compute the estimated AS using a beam pattern-based approach. To do so, it is first noted that the singular value decomposition (SVD) of the sample covariance matrix \hat{R} (see Appendix D) is given by:

\hat{R}=UΛU^{H}, where
U=[u₁ u₂ . . . u_{N}_{ᵣ}] and Λ=diag([s₁ s₂ . . . S_{N}_{ᵣ}]).

Thus, the beam pattern of \hat{R} is given by Equation 4 as follows:

$$B ( {θ}_{j} ) = {\sum }_{k = 1}^{{N}_{r}} {S}_{k} {\vert {a ( {θ}_{j} )}^{H} {u}_{k} \vert}^{2} , \qquad Eqn . 4$$

where α(θⱼ) represents the Nᵣ×1 array vector corresponding to the j-th angular grid θⱼ∈[−π/2, π/2].

Therefore, using a tunable threshold β, which may represent a predetermined threshold power level, the AS estimator block 1602 may estimate candidate AoAs (i.e. the main beam locations) as angles that satisfy B(θₖ)≥β. Finally, the AS estimator block 1602 may be configured to implement a peak finder to remove sidelobe angles, with a final estimate of AoAs being stored in a set Ω, which represents a set of AS data output by the AS estimator block 1602.

In a second non-limiting and illustrative scenario, the AS estimator block 1602 may compute the estimated AS using an MLE-based approach. To do so, the power

$$p = \{ {p}_{k} \} in angular bins = Ω = \{ {θ}_{k} ∈ [ - \frac{π}{2} , \frac{π}{2} ] \}$$

is first estimated as follows:

ρ_{MLE} argnaxₚƒ(Ĥ(k);φ, such that:

$${\sum }_{k} {p}_{k} = 1 ,$$

$${p}_{k} \geq 0 ,$$

where ƒ(Ĥ(k); p(θ)) represents the probability density function of CSI Ĥ(k) as parametrized by the power in the angular bins. In this scenario, estimated AS output by the AS estimator block 1602 corresponds to the result of the MLE-based computations. It is noted that the term “p” in the context used in this Section is used with respect to the AS estimate unless otherwise noted, which was used in the section above to refer to the PDP estimate.

It is noted that the AS estimator block 1602 is optional, as the AS may alternatively be estimated via any of the trained neural network models as described herein, such as those discussed in Section I above with respect to FIGS. 7A-7C. Thus, the CSI provided to the AS estimator block 1602 may be estimated via any of the trained neural network models discussed above in Section I or, alternatively, the CSI and the AS provided to the AS estimator block 1602 may be estimated via any of the trained neural network models discussed in Section I above.

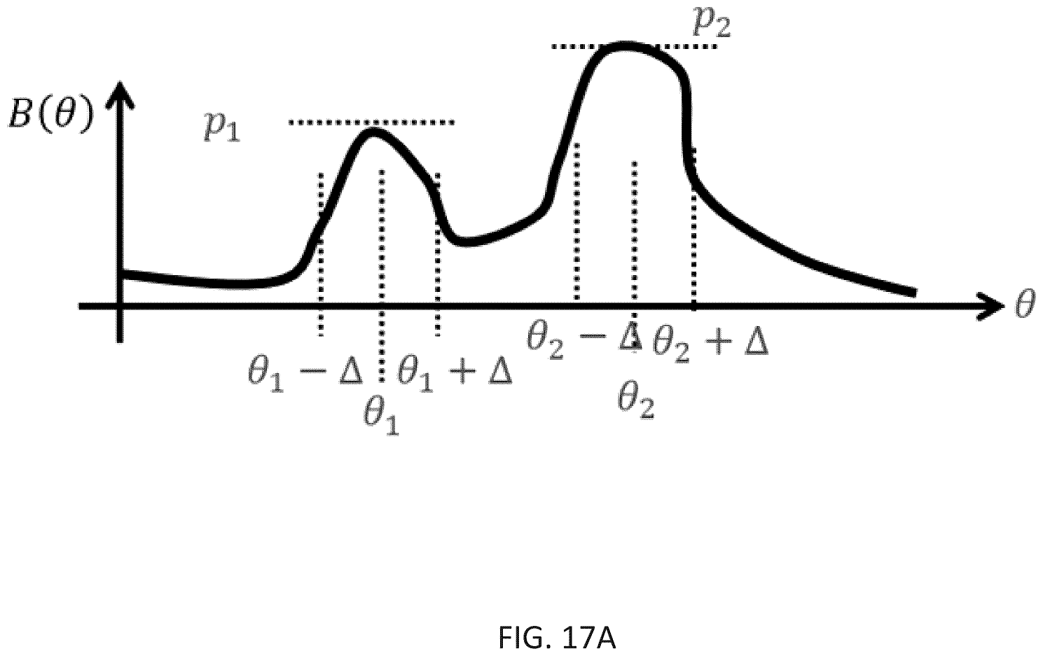

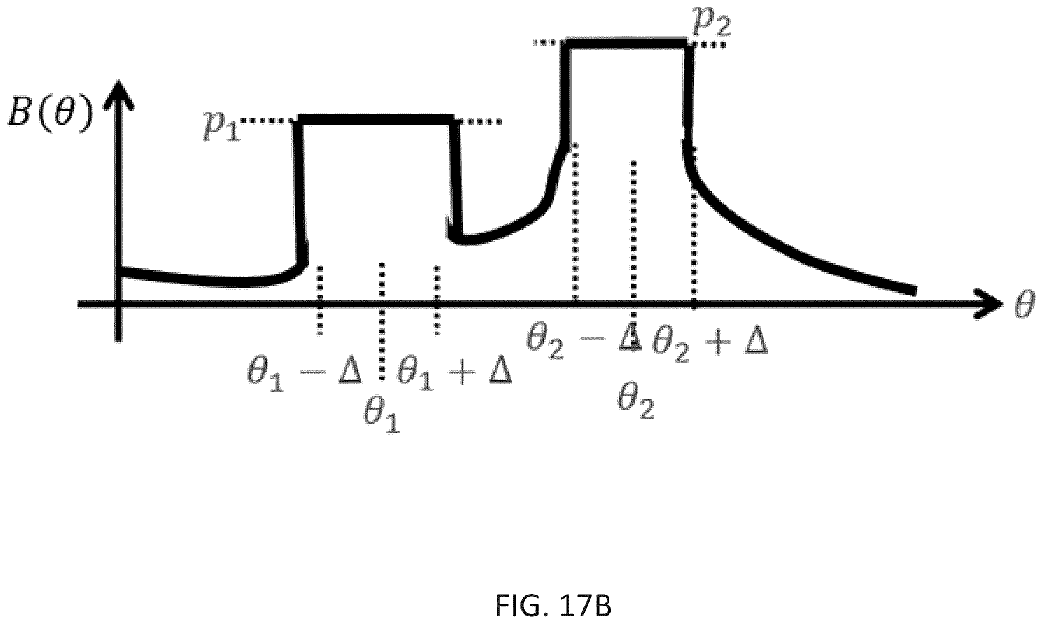

In any event, the estimated AS represents a distribution of received power at different angle of arrivals (AoAs), which is then provided to the artificial power injection block 1604. FIG. 17A illustrates in a graphical form a representation of an AS that may be provided to the artificial power injection block 1604 in accordance with the disclosure. Of course, the AS as shown in FIG. 17A is provided as a non-limiting and illustrative scenario for ease of explanation.

It is noted that with respect to wireless channel variations, the variations of the AoA over time is much slower compared to that of the CSI. Nonetheless, small variations in the AoA may still cause several dBs of degradation in the received power. Thus, to be robust to such variations, the disclosure as discussed herein implements the artificial power injection block 1604 to inject artificial power in the angular spectrum within a predefined vicinity of the main beams in the estimated AS that was output by the AS estimator block 1602. The “vicinity” in this context is defined as a Δθ angular value representing ±θ degrees, and thus Δθ represents a predetermined value or may alternatively be selected (which may include dynamic selections that may change over time during operation) that are based upon one or more suitable conditions being met. Such conditions may include the mobility level of each UE or other communication device with which the beamforming pattern as discussed herein is used to perform wireless communications. In other words, the mobility level may be with respect to the communication device from which a wirelessly received signal is transmitted, such that the Δθ value is increased with an increasing mobility of the communication devices from which signals are received.

The mobility level may be determined using any suitable techniques that may determine the movement of a communication device over time, which may be performed via any suitable computing device in which the architecture 1600 is implemented. Thus, the Δθ value may be selected to correspond to a range of mobility values that may include communication device velocity, the distance of displacement of a communication device over a predetermined time period, etc. This information may be determined, in some scenarios, from data that may be included in the wirelessly received signal.

Thus, the artificial power injection block 1604 may be configured to first identify each main beam location within the AS by determining locations at which the received power exceeds a received power level threshold. In other words, and as shown in FIG. 17A, the AS may represent a distribution of received power at different angles of arrival of the received signal. The artificial power injection block 1604 may identify main beam locations applying any suitable number of conditions that result in the identification of each of the main beams, such as p1 and p2 as shown in FIG. 17A. This may include the use of any suitable techniques, including known techniques, as well as those further discussed herein. The artificial power injection block 1604 may identify each main beam location by determining the AoA locations within the AS having the highest received power levels (i.e. those exceeding a threshold power level), and then identifying the main beam locations by grouping these AoA locations according to a delta value (i.e. the Δθ angular value) to ensure a separation between each of the main beams. In an illustrative and non-limiting scenario, the main beam locations may correspond to the AoA candidates identified by the AS estimator block 1602, which was used to compute the estimated AS that was output to the artificial power injection block 1604.

In another scenario, which may comprise the use of the MLE or the NN based AS estimation as discussed herein, all the angular bins with non-zero power values may be considered as main beam bins, and widening as discussed herein may be performed by injecting power on either side of each main beam bin. In this scenario, a final normalization is then performed to ensure that the total power is 1.

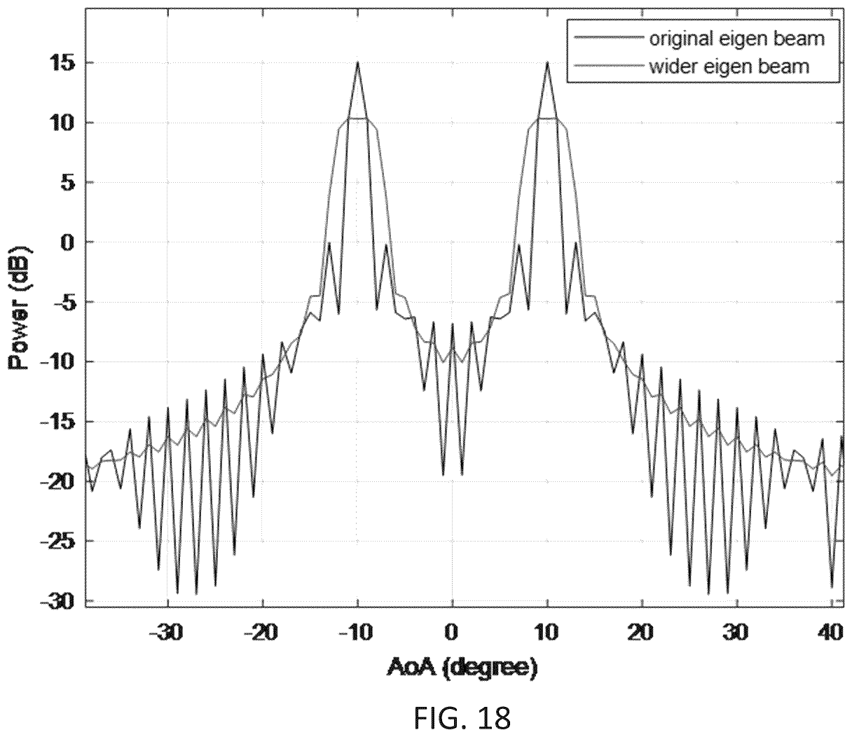

In any event, once each of the main beams has been identified in this manner, the artificial power injection block 1604 is further configured to perform an injection (i.e. addition) of artificial power to generate a widened spatial covariance matrix. The widened spatial covariance matrix is then used to compute a beamforming pattern using eigenvectors that have been derived via an eigen decomposition process, as discussed in further detail below. The resulting beamforming pattern comprises a widening of the main beams, which corresponds to widened eigen beams as illustrated in FIG. 17B. Thus, via the injection of artificial power in the vicinity of the main beam locations, each main beam may be widened, as shown via a comparison between FIGS. 17A and 17B. FIG. 18 also illustrates a simulation result for a two-finger eigen beam using Equation 4 as described above, with AoAs at ±10°. The techniques described herein also enable each “finger” to be widened simultaneously (N_{w}Δ=1° in this case).

Thus, the computations implement the widened eigenvectors as further discussed herein to obtain one or more wide eigen beams, which may be used as a beamforming pattern. The term “wide” in this context means that the spatial covariance matrix that is generated as a result of the injection of artificial power yields wider eigen beams compared to a spatial covariance matrix that would be generated if the additional power was not added. Two illustrative and non-limiting scenarios are provided directly below with respect to how the artificial power injection block 1604 may perform the artificial power injection to compute the wide spatial covariance matrix.

For each of these techniques, the artificial power injection block 1604 adds artificial power in the estimated AS, and an updated AS is then synthesized by the artificial power injection block 1604 using array vectors. It is noted that, for each of these techniques, the injection of artificial power refers to the addition of power in a virtual sense. In other words, the artificial power injection block 1604 is configured to compute the wide spatial covariance matrix from a modified AS that has been synthesized by considering additional power that is added in the AoA main beam locations, although this additional power not actually been received.

In the first illustrative and non-limiting scenario, the artificial power injection block 1604 computes the wide spatial covariance matrix using a sample covariance matrix and the estimated AS (i.e. computed via the AS estimation block 1602 or via the DKE-NN models in Section I). For this technique, the artificial power injection block 1604 adds power in the vicinity of each identified main beam within the AS as if power was actually received at those AoAs. Again, the location of the AoAs within the AS with respect to each main beam at which the artificial power is added (i.e. the OAB angular value) may be based upon a mobility level of a device from which the wirelessly received signal is transmitted, or any other suitable conditions.

In any event, the widened covariance matrix is represented as follows:

$${R}_{wide} = \hat{R} + ρ {\sum }_{k ∈ Ω} {\sum }_{b = 1}^{{N}_{w}} {p}_{k} a ( {θ}_{k} - b Δ ) {a}^{H} ( {θ}_{k} - b Δ ) + {p}_{k} a ( {θ}_{k} + b Δ ) {a}^{H} ( {θ}_{k} + bΔ ) ,$$

where

$$ρ = \frac{trace ( \hat{R} )}{{N}_{r}}$$

$$and$$

$${\sum }_{k ∈ Ω} {p}_{k} = \frac{1}{2 {N}_{w}} ,$$

and N_{w}≥1 represents the number of angular bins for injecting artificial power on each side of estimated AS.

For the second illustrative and non-limiting scenario, the artificial power injection block 1604 computes the wide spatial covariance matrix using only the estimated AS. That is, in this scenario, only the estimated AS is utilized, and artificial power is injected in the vicinity (i.e. the Δθ angular value) of each of the main beam AoAs to construct widened spatial covariance matrix, which is represented as follows:

$${R}_{wide} = {\sum }_{k ∈ Ω} {p}_{k} a ( {θ}_{k} ) {a}^{H} ( {θ}_{k} ) + {\sum }_{k ∈ Ω} {\sum }_{b = 1}^{{N}_{w}} {p}_{k} a ( {θ}_{k} - b Δ ) {a}^{H} ( {θ}_{k} - b Δ ) + {p}_{k} a ( {θ}_{k} + b Δ ) {a}^{H} ( {θ}_{k} + b Δ ) ,$$

where

$${\sum }_{k ∈ Ω} {p}_{k} = \frac{1}{2 {N}_{w} + 1} ,$$

and N_{w}≥1 is the number of angular bins for injecting artificial
power on each side of estimated AoA.

For both of these techniques, the number of angular bins may be computed from the Δθ angular value based upon the granularity that is selected for the angular bins, which may be based upon the particular application, processing resources, etc.

The first technique described above is influenced by cross-terms (i.e. channel phase) due to the addition of the sample covariance matrix, whereas the second technique has no impact of channel phase since it has no cross terms in building R_{wide}. Also, R_{wide} in the second technique has a larger rank than R_{wide} in the first technique, and therefore the widened spatial covariance matrix in each case provides different compression performance. In a non-limiting and illustrative scenario, the first and the second techniques may be dynamically switched based upon the mobility levels of the device(s) from which signals have been received, or any other suitable conditions.

Regardless of which technique is implemented, once the artificial power injection block 1604 computes the widened spatial covariance matrix, this is provided to the eigen decomposition block 1606. The eigen decomposition block 1606 is configured to perform an eigen decomposition on the widened spatial covariance matrix to compute what are referred to herein as wide (or widened) eigen beamforming vectors, or simply as wide (or widened) eigenvectors. As noted above, the term “wide” in this context means that the eigen beamforming vectors computed from the eigen decomposition on the widened spatial covariance matrix are wider than those that would be computed from an eigen decomposition that is performed on a typical spatial covariance matrix, i.e. a spatial covariance matrix that is generated without the addition of power in the AS as discussed herein.

The eigen decomposition block 1606 is configured to perform the eigen decomposition on the widened spatial covariance matrix using any suitable techniques, including known techniques, to determine the wide eigen beamforming vectors. However, two additional techniques are provided in further detail below as non-limiting and illustrative scenarios.

The first of these techniques comprises a singular value decomposition (SVD) of R_{wide} (i.e. the widened spatial covariance matrix) to find the wide eigen beamforming vectors, whereas the second technique comprises performing a QR decomposition of the widened spatial covariance matrix. In any case, the widened spatial covariance matrix may be represented as follows:

R_{wide}=U_{wide}Λ_{wide} U_{wide}^{H}

Next, the eigen decomposition block 1606 performs beamforming of data symbols in future OFDM symbols received after a time i, such as:

$$\tilde{y} ( n + τ ) = {\tilde{U}}_{wide}^{H} y ( n + τ ) ,$$

where Ũ_{wide} is a subset of wide eigenvectors in U_{wide}.

Thus, the eigen decomposition block 1606 is configured to compute the wide eigen beamforming vectors. Once the wide eigen beamforming vectors are computed in this manner, the beamforming pattern may be computed from the wide eigen beamforming vectors using any suitable techniques, including known techniques. This may comprise the computation of beamforming weights that may be applied to the individual antenna elements of the applicable antenna array for subsequent wireless communications, resulting in a beamforming pattern comprising widened eigen beams. The beamforming pattern then be used for the communication of subsequent signals to one or more communication devices, as discussed herein. The computation of the eigen beamforming vectors and the resulting beamforming pattern may advantageously be performed using a single OFDM symbol carrying SRS. Moreover, the use of the widened eigen beams enables a more robust beamforming as described herein, and mitigates the issues regarding the stationary and non-stationary cases as described in Appendix D.

### B. A Computing Device Implementation

Turning back to FIG. 13, the computing device 1300 as described above in Section I may likewise be implemented to perform any of the widening eigen beam forming techniques as discussed in this Section. Thus, the executable instructions stored in the memory 1306 may additionally or alternatively comprise the widened eigen beam computations module 1350, which may enable any of the computations discussed in this Section with respect to the Eigen beamforming algorithm to be functionally realized. Thus, and as further discussed below, the instructions stored in widened eigen beam computations module 1350 may facilitate, in conjunction with execution of instructions via the processing circuitry 1302, the computing device 1300 realizing the entirety or a portion of the architecture 1600 and/or the data flow as described with respect to the architecture 1600.

Although the computing device 1300 is shown in FIG. 13 as comprising modules identified with the techniques described in both Sections I and II, this is provided in a non-limiting and illustrative manner. The computing device 1300 may comprise any of the modules as shown in FIG. 13, and thus perform any combination of the various techniques as discussed in Sections I and/or II of the present disclosure. Thus, the computing device 1300 may be configured to perform any of the techniques as described in Section I, to perform any of the techniques described in Section II, or to perform any of the techniques described in both Sections I and II.

Further, any of the statements made in Section I with respect to the computing device 1300 are likewise applicable with respect to any of the techniques that may be performed in Section II. Again, the modules shown in FIG. 13 that are identified with the widened eigen beam computations module 1350 are also provided for ease of explanation regarding the functional association between hardware and software components. Thus, the processing circuitry 1302 may execute the instructions stored in these respective modules in conjunction with one or more hardware components to perform any of the various functions as discussed herein. Although illustrated as separate modules, this is for ease of explanation, and it will be understood that the memory 1306 may store computer-readable instructions in any suitable format as an executable set of data instructions such that any of the functionality as described herein may be performed via execution of the instructions stored in the memory 1306.

The CSI/AS computation module 1351 may represent the functionality described herein with reference to the CSI and/or AS computations via the AS estimator block 1602. Thus, in some non-limiting and illustrative scenarios, the CSI/AS computation module 1351 may facilitate, in conjunction with execution of instructions via the processing circuitry 1302, the computing device 1300 performing CSI and/or AS estimates. Again, one or both of these computations are optional, as these estimates may alternatively be derived from the outputs of the DKE-NN trained models as discussed above in Section I. When performed, the computing device 1300 may compute the CSI and/or AS using any suitable techniques, such as those described with respect to the AS estimator block 1602 as described in this Section, and/or known techniques.

The wide spatial covariance matrix computation block 1353 may represent the functionality described herein with reference to the computation of the wide spatial covariance matrix via the artificial power injection block 1604. Thus, in some non-limiting and illustrative scenarios, the wide spatial covariance matrix computation block 1353 may facilitate, in conjunction with execution of instructions via the processing circuitry 1302, the computing device 1300 performing the wide spatial covariance matrix computations as discussed in this Section, which may comprise any of the computational techniques described herein as explained above with respect to the functions performed via the artificial power injection block 1604.

The wide eigen vector computation block 1355 may represent the functionality described herein with reference to the computation of the wide eigenvectors from the generated wide spatial covariance matrix via the eigen decomposition block 1606. Thus, in some non-limiting and illustrative scenarios, the wide eigenvector computation block 1355 may facilitate, in conjunction with execution of instructions via the processing circuitry 1302, the computing device 1300 computing the wide eigenvectors using an eigen decomposition of the wide spatial covariance matrix. This may comprise any of the computational techniques described herein, as explained above with respect to the functions performed via the eigen decomposition block 1606.

The beamforming control module 1357 may represent the functionality described herein with reference to performing any suitable type of beamforming using the wide eigenvectors as discussed herein. Thus, in some non-limiting and illustrative scenarios, the beamforming control module 1357 may facilitate, in conjunction with execution of instructions via the processing circuitry 1302, the computing device 1300 performing beamforming by computing and applying weights to the antennas in the transmit antenna array 1320 and/or the receive antenna array 1330. This beamforming may be performed utilizing the CSI and AS estimates output via the trained DKE-NN model, such as any of those discussed herein the respect to FIGS. 7A-7C. The beamforming pattern may comprise widened eigen beams, as discussed in this Section, and the beamforming may comprise any suitable beamforming techniques using the wide eigenvectors, including known techniques. Once the beamforming has been performed, the computing device 1300 may transmit signals via the transmit antenna array 1320 to the wireless device from which the signals used to compute the beamforming pattern were received. Additionally or alternatively, the computing device 1300 may receive subsequent signals via the receive antenna array 1330 from the wireless device from which the signals used to compute the beamforming pattern were received.

### C. A Process Flow

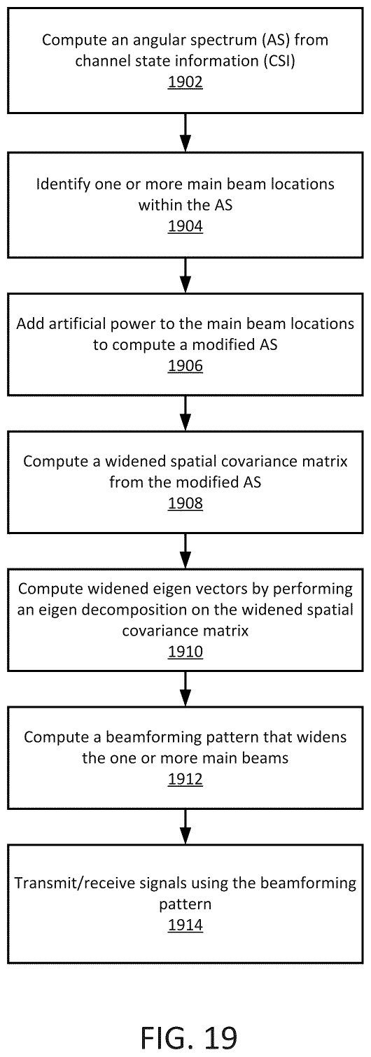

FIG. 19 illustrates a process flow, in accordance with the present disclosure. With reference to FIG. 19, the flow 1900 may be a computer-implemented method executed by and/or otherwise associated with one or more processors (processing circuitry) and/or storage devices. These processors and/or storage devices may be associated with one or more computing components identified with any suitable computing device (such as the base station 102, the UEs 104, the computing device 1300, etc.). The one or more processors identified with one or more of the computing components as discussed herein may execute instructions stored on any suitable computer-readable storage medium, which may or may not be shown in the Figures. The flow 1900 may include alternate or additional steps that are not shown in FIG. 19 for purposes of brevity, and may be performed in a different order than the steps shown in FIG. 19.

Flow 1900 may begin when one or more processors compute (block 1902) an angular spectrum (AS) using CSI. This may include the estimation of the AS estimator block 1602 using a computed CSI, which may be computed via the trained DKE-NN models as discussed in Section I or via any other suitable techniques. The AS may likewise optionally be provided via the trained DKE-NN models as discussed in Section I.

Flow 1900 may include one or more processors identifying (block 1904) one or more main beam locations within the AS. This may comprise the identification of AoAs within the AS that are identified with a received power level exceeding a predetermined threshold value, as discussed herein.

Flow 1900 may include one or more processors adding (block 1906) artificial power to the AS to compute a synthesized, modified AS. This may include the artificial power injection block 1604 virtually adding power to the estimated AS at the locations of the main beams, as discussed above.

Flow 1900 may include one or more processors computing (block 1908) a widened spatial covariance matrix from the modified AS. This may include the artificial power injection block 1604 computing the widened spatial covariance matrix in accordance with any of the techniques as discussed herein.

Flow 1900 may include one or more processors computing (block 1910) widened eigenvectors by performing an eigen decomposition on the widened spatial covariance matrix. This may include estimating the eigen decomposition block 1606 computing the widened spatial covariance matrix in accordance with any of the techniques as discussed herein.

Flow 1900 may include one or more processors computing (block 1912) a beamforming pattern from the widened eigenvectors. This may include computing the beamforming weights that are to be applied to antennas of an applicable antenna array, which may then realize the beamforming pattern comprising widened eigen beams as discussed herein.

Flow 1900 may include one or more processors transmitting and/or receiving (block 1914) signals via an antenna array in accordance with the beamforming pattern formed via application of the computed weights, i.e. the widened eigen beams. This may include the transmission of signals via the transmit antenna array 1320 to the wireless device from which the signals were received and used to compute the beamforming pattern. Additionally or alternatively, this may include receiving subsequent signals via the receive antenna array 1330 from the wireless device from which the signals were received and used to compute the beamforming pattern.

### D. O-RAN Implementation and Simulation Results

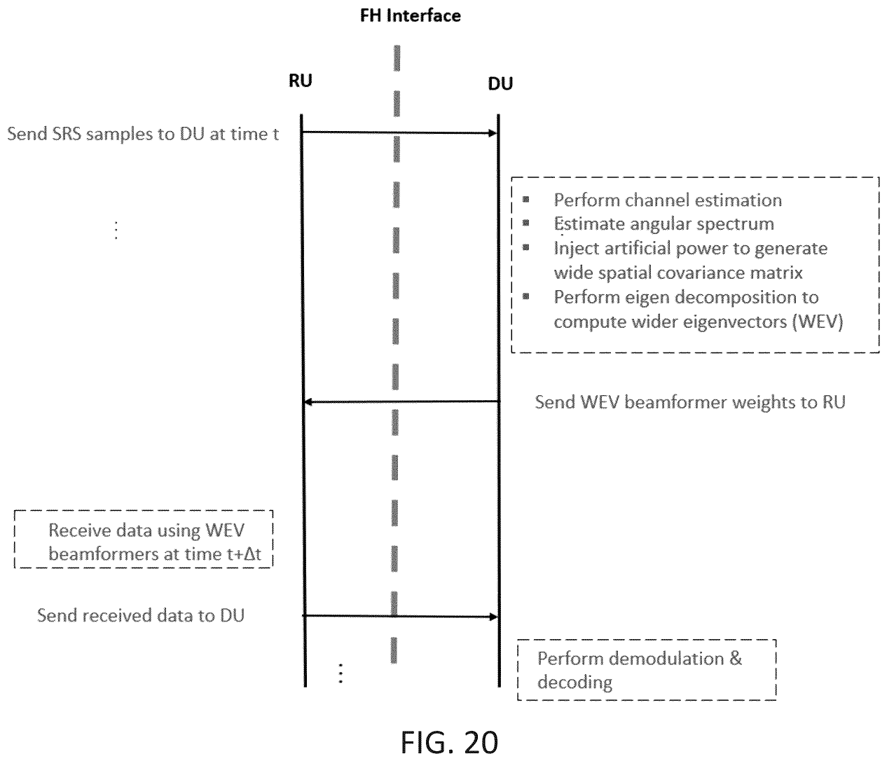

FIG. 20 illustrates a block diagram of a front-haul interface, in accordance with the disclosure. Again, the techniques described throughout the disclosure may be implemented in any suitable computing device, as discussed in further detail in Section I with respect to the computing device 1300, and which may include the base station 102 as shown and discussed in further detail with respect to FIG. 1. Additionally or alternatively, the techniques as discussed herein may be implemented as part or any suitable computing devices that constitute part of one or more networks, which may include an open radio access network (O-RAN) in a non-limiting and illustrative scenario. An O-RAN functional split 7.2 is illustrated in further detail in FIG. 20, which illustrates signaling between a radio unit (RU) and a distributed unit (DU) via a fronthaul (FH).

As shown in FIG. 20, the FH interface is configured to transfer SRS samples received from a RU to a DU across the FH interface. The DU may implement any of the techniques described in Section I and/or Section II to estimate the CSI and the angular spectrum using the received SRS samples. The DU may also implement the flow as shown and discussed in Section II with respect to FIG. 16 to perform artificial power injection at main beam locations, to compute the widened spatial covariance matrix, and to perform eigen decomposition on the widened spatial covariance matrix to compute the wide eigenvectors. The beamforming weights may then be computed and transmitted to the RU from the DU across the FH interface, and the DU may utilize the beamforming weights to perform beamforming for subsequent communications, which are forwarded to the DU across the FH interface as shown in FIG. 20.

The O-RAN architecture as shown in FIG. 20 provides the basis for simulations that have been performed to demonstrate the feasibility of the beamforming techniques discussed in this Section. The simulation set up is abstracted based on open RAN alliance functional split option 7.2. The CSI acquisition is performed at the RU using the SRS received on each antenna element. After 5 ms (worst gap when SRS allocation period is 5 ms) data symbols are received that have to be forwarded to the DU for demodulation and decoding. To minimize the amount of data to be forwarded from the RU to the DU, data symbols are compressed at the RU before forwarding the data symbols to the DU.

The simulation set up design considers the following two compression schemes:
Method 1: A sample covariance matrix is computed at the RU using the CSI acquired from the SRS. SVD or QR is performed to obtain \hat{R}=UΛU^{H}. One or more eigen beamforming vectors from U are used to compress data symbols that are received 0˜5 ms later.
Method 2: A sample covariance matrix \hat{R} is computed at the RU using the CSI acquired from SRS and averaged over latest T SRS instances. More precisely:

$$\hat{R} = \frac{1}{T} {\sum }_{t} {\hat{R}}_{t} ,$$

where \hat{R}ₜ is the sample covariance matrix estimated at the t-th SRS instant. SVD or QR is performed to obtain \hat{R}=UΛU^{H}. One or more eigen beamforming vectors from U are used to compress data symbols that are received up to 5 ms later.

First, the wide eigen beamforming techniques described in this Section are evaluated using a wide sense stationary channel model as per the 3GPP definition, as noted in Appendix D. The simulation parameters are shown in Table 4 below.

TABLE 4
Wide sense stationary channel model parameters

| Parameter | Value | |
|---|---|---|
| FFT size | 4096 | |
| Subcarrier spacing | 30 | kHz |
| SRS BW | 272 | RB |
| SRS periodicity | 5 | ms |
| SRS chest | Least Square | |
| DMRS chest | Ideal | |
| #UE | 1 (single antenna) | |
| #gNB antennas | 64 | |
| Comb Type | 2 | |
| # layer per UE | 1 | |
| Channel model | 3GPP CDL-B rms 30 ns | |
| Maximum Doppler | 400 | Hz |

For the simulation, the RU compresses the data symbols from 64 streams down to 16 streams and forwards these to the DU. At the DU, ideal channel estimation is assumed for the demodulation reference symbols (DMRS), and the spectral efficiency (SE) is computed under each compression scheme. The compression performance may then be measured by normalizing the SE of each compression scheme by the SE achieved using an ideal maximal ratio combining (MRC) over all 64 gNB antennas. Such an ideal MRC would also be an upper bound on SE performance for decoding performed at the RU using full data symbols.

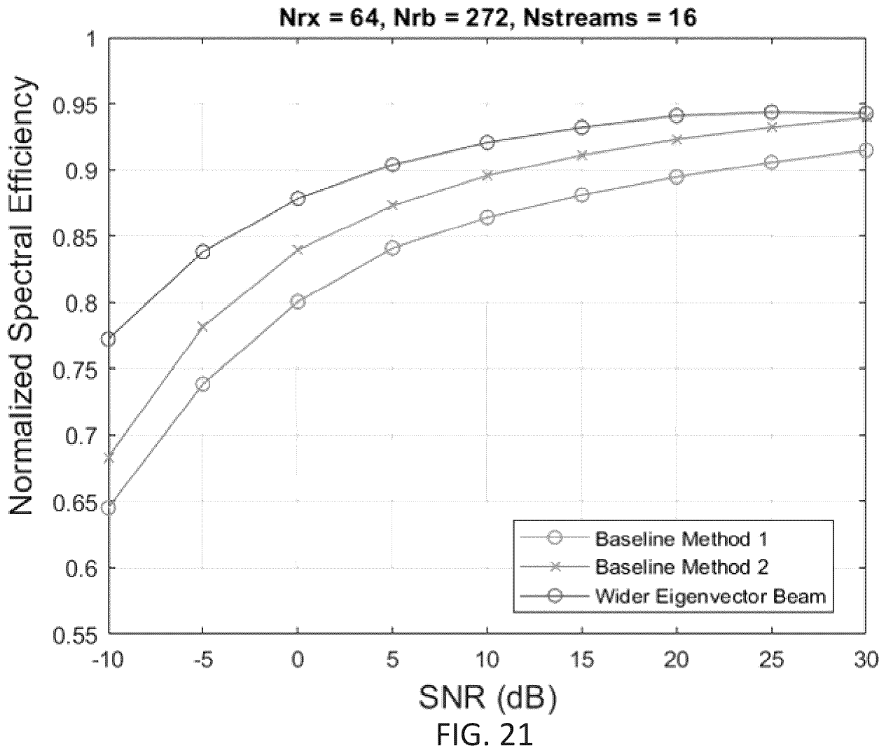

The normalized spectral efficiency is compared in FIG. 21, which illustrates the simulated performance in a wide sense stationary channel. The wide eigen beams are generated as discussed in this Section using an MLE of AoAs (i.e. the MLE-based approach) and widening is performed for Δ=2° using the first technique described above, i.e. computing the wide spatial covariance matrix using a sample covariance matrix and the estimated AS. As shown in FIG. 21, it is clear that at 90% normalized (SE), which is considered a target performance specification, the techniques as discussed in this Section outperform the baseline method 1 by about 18 dB, and outperforms the baseline method 2 by about 8 dB.

Next, non-stationary channel models are considered. In particular, a channel is considered with a time-varying AoA. The simulation parameters and channel parameters are shown in Tables 5 and 6 below, respectively.

TABLE 5
Non-Stationary channel signal parameters

| Parameter | Value | |
|---|---|---|
| FFT size | 2048 | |
| Subcarrier spacing | 15 | kHz |
| SRS BW | 50 | RB |
| SRS periodicity | 5 | ms |

| | |
|---|---|
| SRS chest | Least Square |
| DMRS chest | Ideal |
| #UE | 1 (single antenna) |
| #gNB antennas | 64 |
| Comb Type | 2 |
| # layer per UE | 1 |

TABLE 6
Non-Stationary channel parameters

| Channel Parameter | Value |
|---|---|
| Number of clusters | C = 4 |
| Number of taps per cluster | P = 10 |
| Center AoA per cluster | −50⁰, −15⁰, 15⁰, 75⁰ |
| Angular spread per cluster | 5^{o} |
| Center delay per cluster | Uniform ~ [0, 4.8 micro sec] |
| Delay spread per cluster | ±5% of center delay |
| | (with wrap around) |
| UE Speed | v = 180 kmph => fd = 400 Hz |
| Channel tap | Complex Normal |
| AoA time-variation | ±1.43⁰ every 5 ms |
| Tap delay time-variation | ±1.48 ps every 5 ms |

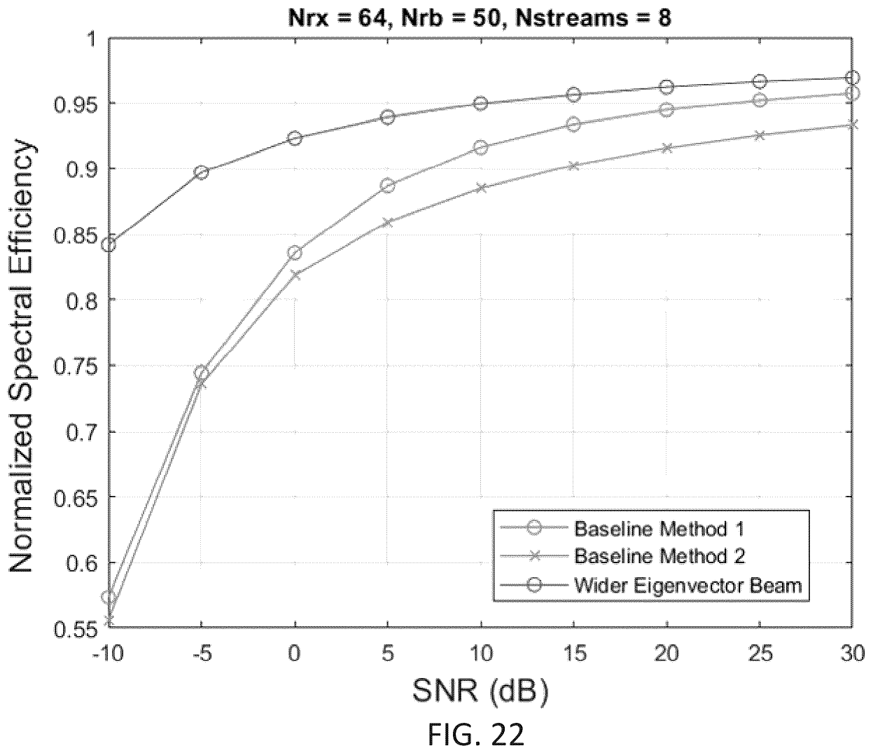

Normalized spectral efficiency is compared in FIG. 22. As shown, at the 90% mark, the techniques as discussed in this Section outperform the baseline methods 1 and 2 by 12 dB and 20 dB, respectively. It should also be noted that when the AoA is time-varying, averaging over multiple SRS instances causes further degradation in performance as seen in baseline method 2.

### General Operation of a First Computing Device

A first computing device is provided. The first computing device comprises a memory configured to store computer-readable instructions, and a processor configured to execute the computer-readable instructions to cause the computing device to: generate, via a multipath propagation channel model that applies a set of predefined signal parameters, training samples identified with a received wireless training signal; calculate, from the training samples, a set of corresponding labels, the set of corresponding labels including a maximum likelihood estimate (MLE) of power received in a quantized delay domain, a MLE of power received in a quantized angle of arrival domain, and corresponding Lagrange multipliers; train a neural network (NN) using training data that comprises the training samples and the set of corresponding labels to generate a trained NN; perform inference via the trained NN to estimate channel state information (CSI) of a wireless channel and an angular spectrum (AS) identified with propagation of a received signal; and perform multiple-input multiple-output (MIMO) antenna beamforming using the CSI and the AS. In addition or in alternative to and in any combination with the optional features previously explained in this paragraph, the AS represents a distribution of received power at different angles of arrival of the received signal. In addition or in alternative to and in any combination with the optional features previously explained in this paragraph, the computer-readable instructions, when executed the processor, cause the computing device to perform the inference to estimate one or more statistical channel parameters, and to estimate the CSI of the wireless channel identified with the propagation of the received signal based upon the estimated one or more statistical channel parameters. In addition or in alternative to and in any combination with the optional features previously explained in this paragraph, the computer-readable instructions, when executed the processor, cause the computing device to further train the NN using training data that comprises the CSI, and to perform the inference to estimate the AS of the wireless channel based upon the estimated CSI in accordance with the further trained NN. In addition or in alternative to and in any combination with the optional features previously explained in this paragraph, the NN comprises a domain knowledge enhanced neural network (DKE-NN). In addition or in alternative to and in any combination with the optional features previously explained in this paragraph, the received signal is received via an antenna array, and the computer-readable instructions, when executed the processor, cause the computing device to perform the inference by estimating the CSI per antenna by (i) computing an estimated power delay profile (PDP) per antenna of the antenna array, and (ii) computing an average of the estimated PDP per antenna. In addition or in alternative to and in any combination with the optional features previously explained in this paragraph, the computer-readable instructions, when executed the processor, cause the computing device to perform the inference to estimate the AS that represents a distribution of received power at different angles of arrival with respect to the antenna array by (i) estimating an AS per sub-carrier identified with the received signal, (ii) averaging a covariance matrix over each one of the sub-carriers, and (iii) estimating the AS from the averaged covariance matrix. In addition or in alternative to and in any combination with the optional features previously explained in this paragraph, the computer-readable instructions, when executed the processor, cause the computing device to perform the inference to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

### General Operation of a Second Computing Device

A second computing device is provided. The second computing device comprises processing circuitry configured to: compute an angular spectrum from channel state information (CSI) identified with a wirelessly received signal, the angular spectrum representing a distribution of received power at different angles of arrival; identify one or more main beam locations by determining locations within the angular spectrum at which the received power exceeds a received power level threshold; and compute a beamforming pattern that widens one or more main beams at the respective one of more main beam locations via a matrix decomposition process that operates on a matrix that is generated as a result of adding artificial power at one or more angular locations with respect to the one of more main beam locations, and a transceiver configured to perform a wireless signal transmission in accordance with the beamforming pattern. In addition or in alternative to and in any combination with the optional features previously explained in this paragraph, the processing circuitry is configured to generate, as the matrix, a widened spatial covariance matrix, and to compute the beamforming pattern as an eigen beamforming pattern by performing, as the decomposition process, an eigen decomposition on the widened spatial covariance matrix. In addition or in alternative to and in any combination with the optional features previously explained in this paragraph, the eigen decomposition comprises a singular value decomposition to compute, as beamforming vectors identified with the beamforming pattern, wide eigenvectors from the widened spatial covariance matrix. In addition or in alternative to and in any combination with the optional features previously explained in this paragraph, the eigen decomposition comprises a QR decomposition to compute, as beamforming vectors identified with the beamforming pattern, wide eigenvectors from the widened spatial covariance matrix. In addition or in alternative to and in any combination with the optional features previously explained in this paragraph, the processing circuitry is configured to compute the beamforming pattern by computing, via the matrix decomposition process, beamforming vectors using, from the wirelessly received signal, a single Orthogonal Frequency-Division Multiplexing (OFDM) symbol carrying a Sounding Reference Signal (SRS). In addition or in alternative to and in any combination with the optional features previously explained in this paragraph, the one or more angular locations with respect to the one of more main beam locations at which the artificial power is added is based upon a mobility level of a device from which the wirelessly received signal is transmitted. In addition or in alternative to and in any combination with the optional features previously explained in this paragraph, the CSI is output via a trained domain knowledge enhanced neural network (DKE-NN), and the trained DKE-NN is trained using training data that comprises training samples that are generated via a multipath propagation channel model and a set of corresponding labels, the labels including a maximum likelihood estimate (MLE) of power received in the quantized delay domain, a MLE of power received in the quantized angle of arrival domain, and corresponding Lagrange multipliers.

### General Operation of a Computer-Readable Medium

A non-transitory computer-readable medium is provided. The non-transitory computer-readable medium has instructions stored thereon, that when executed by processing circuitry of a computing device, cause the computing device to: generate, via a multipath propagation channel model that applies a set of predefined signal parameters, training samples identified with a received wireless training signal; calculate, from the training samples, a set of corresponding labels, the set of corresponding labels including a maximum likelihood estimate (MLE) of power received in a quantized delay domain, a MLE of power received in a quantized angle of arrival domain, and corresponding Lagrange multipliers; train a domain knowledge enhanced neural network (DKE-NN) using training data that comprises the training samples and the set of corresponding labels to generate a trained DKE-NN; perform inference via the trained DKE-NN to estimate channel state information (CSI) of a wireless channel and an angular spectrum (AS) identified with propagation of a received signal; identify one or more main beam locations by determining locations within the AS at which the received power exceeds a received power level threshold; and compute a beamforming pattern using the CSI and the AS that widens one or more main beams at the respective one of more main beam locations via a matrix decomposition process that operates on a matrix that is generated as a result of adding artificial power at one or more angular locations with respect to the one of more main beam locations. In addition or in alternative to and in any combination with the optional features previously explained in this paragraph, the AS represents a distribution of received power at different angles of arrival of the received signal. In addition or in alternative to and in any combination with the optional features previously explained in this paragraph, the computer-readable instructions, when executed the processing circuitry, cause the computing device to perform the inference via the trained DKE-NN to estimate one or more statistical channel parameters and corresponding Lagrange multipliers, and to estimate the CSI by applying Karush Kuhn Tucker (KKT) conditions to the one or more statistical channel parameters and corresponding Lagrange multipliers. In addition or in alternative to and in any combination with the optional features previously explained in this paragraph, the computer-readable instructions, when executed the processing circuitry, cause the computing device to: calculate, as the matrix, a widened spatial covariance matrix; and compute the beamforming pattern as an eigen beamforming pattern by performing, as the decomposition process, an eigen decomposition on the widened spatial covariance matrix to compute, as beamforming vectors identified with the beamforming pattern, wide eigenvectors from the widened spatial covariance matrix, the eigen decomposition comprising one of (i) a singular value decomposition, or (ii) a QR decomposition. In addition or in alternative to and in any combination with the optional features previously explained in this paragraph, the computer-readable instructions, when executed the processing circuitry, cause the computing device to determine the angular location with respect to the one or more main beams at which the artificial power is added is based upon a mobility level of a device from which the wirelessly received signal is transmitted.

### Appendix A—Modeling of PHY Parameters

A Model for Quantized PDP: Delay spread is modeled up to cyclic prefix duration t_{CP} by quantizing delay into N_{b} bins. As shown in FIG. 3, the delay bin width is

$${T}_{seg} = \frac{{t}_{CP}}{{N}_{b}}$$

with bin boundaries at times t₀, t₁, . . . , t_{N}_{_{b}}₋₁ and bin power ρ(0), ρ(1), . . . , ρ(N_{b}−1), respectively.

Under the assumption of uncorrelated multipath scattering, the autocovariance matrix of signal Yₘ(k) for the quantized PDP model shown above is given by Equation A1 as follows:

$$K = {\sum }_{b = 0}^{{N}_{b} - 1} p ( b ) {R}_{b} + \frac{1}{SNR} {I}_{Q} , \qquad Eqn . A 1$$

$$where$$

$${R}_{b} = Toeplitz ( \begin{matrix}1 , & \frac{\begin{matrix}( {e}^{- i 2 π d Δ {fT}_{seg}} - 1 ) \\ {e}^{- i 2 π d Δ {ft}_{b}}\end{matrix}}{- i 2 π d Δ f {T}_{seg}} , & … & \frac{\begin{matrix}( {e}^{- i 2 π ( Q - 1 ) d Δ {fT}_{seg}} - 1 ) \\ {e}^{- i 2 π ( Q - 1 ) d Δ {ft}_{b}}\end{matrix}}{- i 2 π ( Q - 1 ) d Δ {fT}_{seg}} ) ,\end{matrix}$$

and

Δƒ is the sub-carrier spacing in Hz, and d is the pilot spacing in number of sub-carriers.

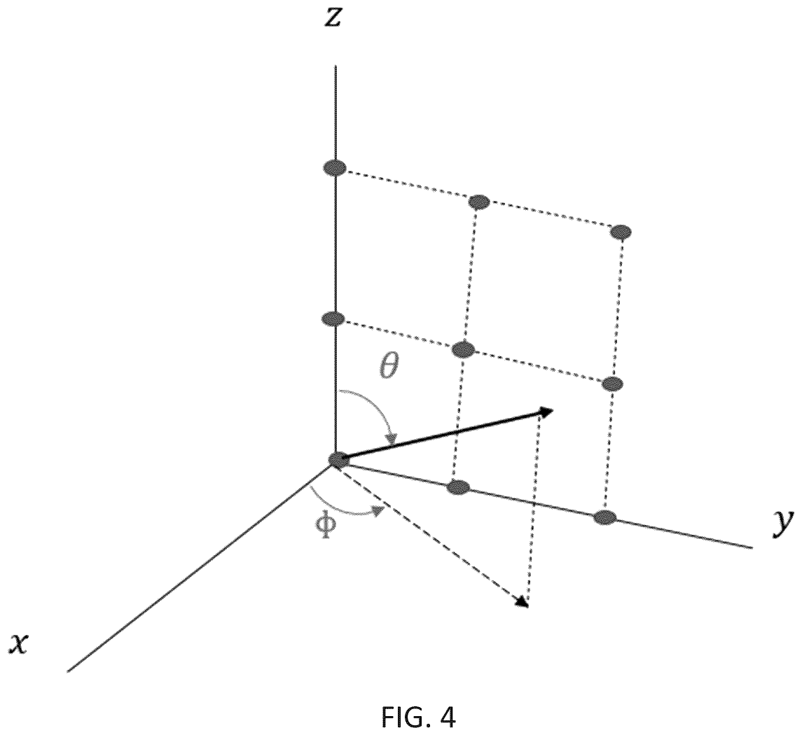

A Model for Quantized Angular Spectrum: A uniform planar array channel model is considered with azimuth AoA ϕ and elevation AoA θ as shown in FIG. 4. Thus, FIG. 4 illustrates a uniform planar array aligned along the yz-plane, with the red dots representing antenna elements.

Thus, the channel impulse response of UPA can be expressed as:

$$h ( τ ) = {\int }_{- π / 2}^{π / 2} {\int }_{- π / 2}^{π / 2} h ( τ ; {θ}_{τ} ; {Φ}_{τ} ) a ( {θ}_{τ} ; {Φ}_{τ} ) d {θ}_{τ} d {Φ}_{τ}$$

$$for$$

$$0 \leq τ \leq {t}_{CP} ,$$

where, α(θ_{τ}; ϕ_{τ}) is the Nᵣ×1 array vector corresponding to the channel tap at the τ-th delay, h(τ; θ_{τ}; ϕ_{τ})˜CN(0, ρ(τ; θ_{τ}; ϕ_{τ})), and ∫₀^{t}^{_{CP}}∫_{-π/2}^{π/2}∫_{-π/2}^{π2}ρ(τ: 0_{τ}; ϕ_{τ})dθ_{τ}dϕ_{τ}dτ=1.

By quantizing the elevation AoA into N₁ number of bins, quantizing the azimuth AoA into N₂ number of bins, and quantizing the delay into N₃ number of bins, a 3D channel model is obtained with a bin resolution of

$${Δ}_{θ} = \frac{π}{{N}_{1}} ,$$

$${Δ}_{ϕ} = \frac{π}{{N}_{2}} ,$$

$$and$$

$${Δ}_{τ} = \frac{{t}_{CP}}{{N}_{3}}$$

in elevation angle, azimuth angle, and delay, respectively.

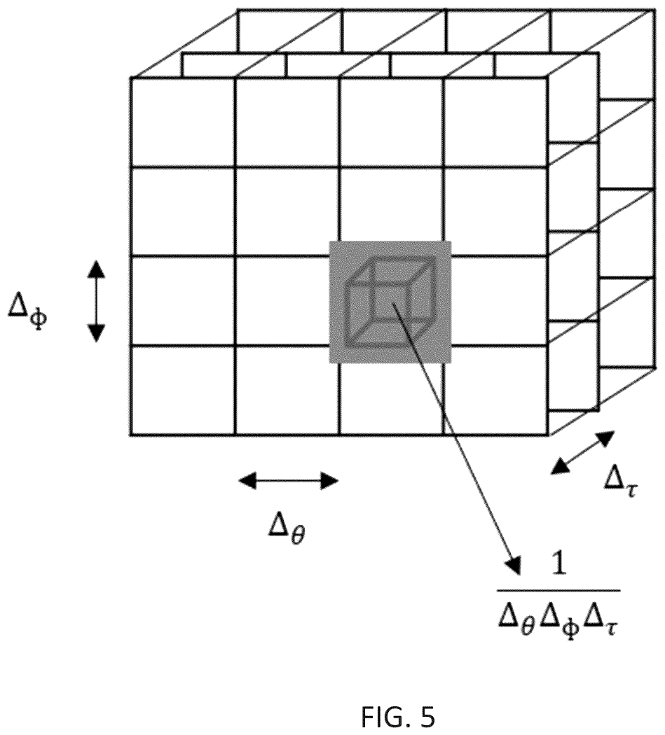

The channel quantization in the angle and the delay domain is further illustrated in FIG. 5. Thus, by further assuming that in each 3D bin, power is uniformly distributed as shown in FIG. 5, the Nᵣ×Nᵣ autocovariance function of channel

$$H ( k ) = [ \begin{matrix}{H}_{0} ( k ) \\ ⋮ \\ {H}_{{N}_{r} - 1} ( k )\end{matrix} ]$$

at the k-th sub-carrier is represented as:

$$E [ H ( k ) {H}^{′} ( k ) ] = {\int }_{0}^{{T}_{CP}} {\int }_{0}^{{T}_{CP}} E [ h ( τ ) {h}^{H} ( \tilde{τ} ) ] {e}^{- j 2 π {f}_{k} ( τ - \tilde{τ} )} d τ d \tilde{τ}$$

For the 3D quantized channel model described above, by integrating over all multipath delays, it is straightforward to show that:

$$E [ H ( k ) {H}^{′} ( k ) ] = {\sum }_{{b}_{1} = 0}^{{N}_{1} - 1} {\sum }_{{b}_{2} = 0}^{{N}_{2} - 1} {p}_{{b}_{1} , {b}_{2}} {R}_{{b}_{1} , {b}_{2}} ,$$

where

$${\sum }_{{b}_{1} = 0}^{{N}_{1} - 1} {\sum }_{{b}_{2} = 0}^{{N}_{2} - 1} {p}_{{b}_{1} , {b}_{2}} = 1 ,$$

$${p}_{{b}_{1} , {b}_{2}} \geq 0$$

is the received power within b₁×b₂ (elevation-by-azimuth) angular bin with covariance matrix:

$${R}_{{b}_{1} , {b}_{2}} = {\int }_{- \frac{π}{2} + {b}_{2} {Δ}_{θ}}^{- \frac{π}{{2}^{}} + ( 1 + {b}_{2} ) {Δ}_{θ}} {\int }_{- \frac{π}{2} + {b}_{1} {Δ}_{Φ}}^{- \frac{π}{{2}^{}} + ( 1 + {b}_{1} ) {Δ}_{Φ}} \frac{1}{{Δ}_{θ} {Δ}_{Φ}} a ( θ ; Φ ) {a}^{H} ( θ ; Φ ) d θ d Φ$$

In practice, the channel estimate Ĥₘ(k) may be obtained from the received signal Yₘ(k) given in Equation 1 above. The Nᵣ×1 estimated channel over all antennas is thus represented as:

$$\hat{H} ( k ) = H ( k ) + E ( k ) ,$$

where E(k) is the channel estimation error. Finally, the autocovariance matrix of Ĥ(k) is represented in accordance with Equation A2 below as follows:

$$K = {\sum }_{{b}_{1} = 0}^{{N}_{1} - 1} {\sum }_{{b}_{2} = 0}^{{N}_{2} - 1} {p}_{{b}_{1} , {b}_{2}} {R}_{{b}_{1} , {b}_{2}} + {σ}^{2} {I}_{{N}_{r}} ,$$

where σ² is the mean squared error (MSE) of channel estimate per sub-carrier per receive antenna.

### Appendix B—Maximum Likelihood Estimator (MLE) of PHY Parameters

### MLE for Power Delay Profile (PDP) Estimation:

Based on the model for quantized PDP described in Appendix A,

$${Y}_{m} = [ \begin{matrix}{Y}_{m} ( 0 ) \\ ⋮ \\ {Y}_{m} ( Q - 1 )\end{matrix} ]$$

represents a complex Gaussian vector with covariance K as given in Equation A1. Therefore, at the m-th receive antenna, the maximum likelihood estimation of PDP is obtained by solving the following dual problem:

$${p}_{MLE} = {arg min}_{p} log \vert K \vert + {Y}_{m}^{′} {K}^{- 1} {Y}_{m} + λ ( {\sum }_{b = 0}^{{N}_{b} - 1} p ( b ) - 1 ) - {\sum }_{b = 0}^{{N}_{b} - 1} {μ}_{b} p ( b )$$

### MLE for AoA Estimation:

Based on the model for quantized AoA as described in Appendix A,

$$\hat{H} ( k ) = [ \begin{matrix}{\hat{H}}_{0} ( k ) \\ ⋮ \\ {\hat{H}}_{{N}_{r} - 1} ( k )\end{matrix} ]$$

represents a complex Gaussian vector with covariance K as given in Equation A2. Therefore, at the k-th sub-carrier, the maximum likelihood estimation of AoA is obtained by solving the following dual problem:

$${p}_{MLE} = arg {min}_{\{ {p}_{{b}_{1} , {b}_{2}} \}} log \vert K \vert + {\hat{H} ( k )}^{′} {K}^{- 1} \hat{H} ( k ) + λ ( {\sum }_{{b}_{1} = 0}^{{N}_{1} - 1} {\sum }_{{b}_{2} = 0}^{{N}_{2} - 1} {p}_{{b}_{1} , {b}_{2}} - 1 ) - {\sum }_{{b}_{1} = 0}^{{N}_{1} - 1} {\sum }_{{b}_{2} = 0}^{{N}_{2} - 1} {μ}_{{b}_{1} , {b}_{2}} {p}_{{b}_{1} , {b}_{2}}$$

### MLE for Timing Offset (TO) and Maximum Delay Spread (MDS) Estimation:

Let t₀ be the TO and t₁ be the MDS of the channel with a rectangular impulse response represented as:

$$h ( τ ) = \{ \begin{matrix}a ( τ ) & for {t}_{0} \leq τ \leq {t}_{0} + {t}_{1} \\ 0 & else\end{matrix} ,$$

$$where ,$$

$$a ( τ ) ∼ CN ( 0 , \frac{1}{{t}_{1}} ) ,$$

$$E [ a ( {τ}_{k} ) {a}^{*} ( {τ}_{l} ) ] = 0$$

$$for$$

$${τ}_{k} \neq {τ}_{l} ,$$

$$and$$

$${t}_{0} + {t}_{1} \leq {t}_{cp} .$$

Using similar arguments as for the PDP estimation shown above, the MLE of TO and MDS may be obtained at the m-th receive antenna by solving the following optimization problem:

$${argmin}_{{x}_{0} , {x}_{1}} \qquad log \vert K \vert + {Y}_{m}^{′} {K}^{- 1} {Y}_{m}$$

subject to constraints: x₀+x₁≤1, x₀≥0, and x₁≥0,
where

$$K = Toeplitz \text{} ( \begin{matrix}1 , & \frac{( {e}^{- i 2 πρ {x}_{1}} - 1 ) {e}^{- i 2 πρ {x}_{0}}}{- i 2 πρ {x}_{1}} , & … & \frac{( {e}^{- i 2 π ( Q - 1 ) ρ {x}_{1}} - 1 ) {e}^{- i 2 π ( Q - 1 ) ρ {x}_{0}}}{- i 2 π ( Q - 1 ) ρ {x}_{1}}\end{matrix} ) + \frac{1}{SNR} {I}_{Q} ,$$

$${x}_{0} = \frac{{t}_{0}}{{t}_{cp}} ,$$

$${x}_{1} = \frac{{t}_{1}}{{t}_{cp}} ρ = d Δf {t}_{cp}$$

A Numerical algorithm for solving the Maximum Likelihood Estimator (Example using AoA Cost):

### 1. Initialization

Set power in each angular bin:

$${p}_{{b}_{1} , {b}_{2}} = \frac{1}{{N}_{1} {N}_{2}}$$

Set Lagrange multipliers for equality constraint to: λ=0

Compute sample covariance:

$$\hat{R} = \frac{1}{N} {Σ}_{k = 0}^{N - 1} \hat{H} ( k ) {\hat{H} ( k )}^{′}$$

Compute spatial covariance for each angular bin

$${R}_{{b}_{1} , {b}_{2}} = {\int }_{- \frac{π}{2} + {b}_{2} {Δ}_{θ}}^{- \frac{π}{{2}^{}} + ( 1 + {b}_{2} ) {Δ}_{θ}} {\int }_{- \frac{π}{2} + {b}_{2} {Δ}_{Φ}}^{- \frac{π}{{2}^{}} + ( 1 + {b}_{1} ) {Δ}_{Φ}} \frac{1}{{Δ}_{θ} {Δ}_{Φ}} a ( θ ; Φ ) {a}^{H} ( θ ; Φ ) d θ d Φ$$

2. Iterations (Repeat Until Sufficient Convergence, i.e. Via Predetermined Conditions)

Compute covariance matrix K given by

$$K = {\sum }_{{b}_{1} = 0}^{{N}_{1} - 1} {\sum }_{{b}_{2} = 0}^{{N}_{2} - 1} {p}_{{b}_{1} , {b}_{2}} {R}_{{b}_{1} , {b}_{2}} + {σ}^{2} {I}_{{N}_{r}}$$

Calculate gradient V̅_{b}_{₁}_{,b}_{₂}=trace ((I−K⁻¹\hat{R})K⁻¹R_{b}_{₁}_{,b}_{₂})

Perform gradient descent with step size μ≥0 as:

$${p}_{{b}_{1} , {b}_{2}} = max ( 0 , {p}_{{b}_{1} , {b}_{2}} - μ ( {∇}_{{b}_{1} , {b}_{2}} - λ ) )$$

Normalize power:

$${p}_{{b}_{1} , {b}_{2}} = \frac{{p}_{{b}_{1} , {b}_{2}}}{{\sum }_{{b}_{1} = 0}^{{N}_{1} - 1} {\sum }_{{b}_{2} = 0}^{{N}_{2} - 1} {p}_{{b}_{1} , {b}_{2}}}$$

Group angular bins having non-zero power in a set S={b₁×b₂:p_{b}_{₁}_{,b}_{₂}>0} and update Lagrangian multipliers using forget factor α

$$λ = ( 1 - α ) λ + α \frac{1}{\vert S \vert} {\sum }_{b ∈ S} {∇}_{{b}_{1} , {b}_{2}} ,$$

where |S| is the cardinality of set S, and α>0 is a forgetting factor.

### 3. Store the Training Data

$${μ}^{*} - {λ}^{*} = trace ( ( I - {K}^{- 1} \hat{R} ) {K}^{- 1} {R}_{{b}_{1} , {b}_{2}} )$$

### Appendix C—Thresholding Algorithm for Post-Processing DKE-NN Output

The DKE-NN inference engines compute an initial estimate of the power ρₙₙ and the reciprocal of Lagrange multipliers νₙₙ. If needed, a thresholding function can be applied to further refine the power estimate. The thresholding algorithm is as follows:

Define a hyper parameter γ≥0. A typical value for γ is 0.01.

For each PDP bin b=0, . . . , N_{b}−1, perform

$$1. δ ( b ) = \frac{1}{1 + {e}^{- v} {nn}^{( b )}}$$

$$2. {p}_{th} ( b ) = \{ \begin{matrix}= {p}_{nn} ( b ) , & if δ ( b ) > γ \\ = 0 , & if δ ( b ) \leq γ\end{matrix}$$

### A. Perform PDP Normalization as

$${P}_{th} ( b ) = \frac{{p}_{t h} ( b )}{{\sum }_{b = 0}^{{N}_{b} - 1} {p}_{t h} ( b )}$$

Although only the PDP thresholding is illustrated in this Appendix, it is noted that the AS MLE could likewise be thresholded in a similar manner using its own corresponding Lagrange multiplier.

### Appendix D—CSI and Covariance Matrix Computations

A uniform linear antenna array is defined with Nᵣ receive antennas. The Nᵣ×1 received signal at time n is thus given by:

$$y ( n ) = {\sum }_{l} {\sum }_{m} {h}_{m , l} ( n ) a ( {θ}_{m , l} ) x ( n - l ) + w ( n ) ,$$

where:
h_{m,l}(n) represents the complex gain of channel from the m-th AoA at the l-th delay and time n,
α(θ_{m,l}) represents the Nᵣ×1 array vector corresponding to the m-th AoA at the l-th delay,
x(n) represents the transmit signal, and
w(n) represents the Nᵣ×1 additive Gaussian noise vector with covariance σ²I.

Since the multipath gain h_{m,l}(n) are independent across delays and AoAs, the covariance matrix of the received signal is given by Equation D1 as follows:

$$R ( n ) = E \{ y ( n ) {y ( n )}^{H} \} = {\sum }_{m , l} {p}_{m} a ( {θ}_{m , l} ) {a}^{H} ( {θ}_{ml ,} ) + {σ}^{2} I , \qquad Eqn . D1$$

$$where , {p}_{m} = {\sum }_{l} E \{ {\vert {h}_{m , l} ( n ) \vert}^{2} \}$$

Thus, the statistical covariance matrix across antennas does not depend on multipath delay and only depends on AoA. This property is exploited by the MLE estimator used for AS estimation as described herein.

Alternatively, assuming the channel is invariant within one OFDM symbol, in Appendix E it is shown that the covariance matrix can be computed using the frequency domain received signal in accordance with Equation D2 as follow:

$$R ≡ R ( n ) = E \{ Y ( k ) {Y ( k )}^{H} \} = {\sum }_{m , l} {p}_{m} a ( {θ}_{m , l} ) {a}^{H} ( {θ}_{ml ,} ) + {σ}^{2} I , \qquad Eqn . D2$$

where Y(k) is the discrete Fourier Transform (DFT) of y(n). Also, in the model in Equation D2, R is fixed within one OFDM symbol, but may change over time if AoAs change.

CSI is measured using the received sounding reference symbol (SRS) as follows:

$$Y ( k ) = H ( k ) X ( k ) + W ( k ) ,$$

where H(k) represents the channel in the k-th sub-carrier, X(k) represents the pilot symbol transmitted in the k-th sub-carrier, and W(k) represents additive Gaussian noise.

Channel estimation is performed using Y(k) to obtain Ĥ(k) and sample covariance matrix is computed in accordance with Equation D3 as follows:

$$\hat{R} = \frac{1}{P} {\sum }_{k ∈ P} \hat{H} ( k ) {\hat{H} ( k )}^{H} \qquad Eqn . D3$$

In Equation D3, P represents the number of pilot sub-carriers in each SRS symbol.

It is noted that the sample covariance matrix in Equation D3 has two issues. First, this is a stationary case. In other words, due to sample averaging, there are cross-terms present in \hat{R}. These cross terms carry the phase information of the channel. Therefore, in future OFDM symbols, the phase information of the new channel will have changed, and therefore the sample covariance matrix becomes outdated. Second, for the non-stationary case, if the channel is non-stationary, for example due to time-variation of AoAs, then \hat{R} has outdated second order statistics.

Appendix E—Covariance Matrix Computations using a Frequency Domain Received Signal

$$y ( n ) = {\sum }_{l} {\sum }_{m} {h}_{m , l} ( n ) a ( {θ}_{m , l} ) x ( n - l ) + w ( n )$$

Let us define hₗ(n)≡Σₘh_{m,l}(n)α(θ_{m,l}). Then:

$$y ( n ) = {\sum }_{l} {h}_{l} ( n ) x ( n - l ) + w ( n )$$

Next, using

$$x ( n ) ≡ \frac{1}{\sqrt{N}} {\sum }_{k} {d}_{k} {e}^{j \frac{2 π k n}{N}} ,$$

where dₖ are the transmitted symbols in the frequency domain, the following is obtained:

$$y ( n ) = \frac{1}{\sqrt{N}} {\sum }_{l} {h}_{l} ( n ) {\sum }_{k} {d}_{k} {e}^{j \frac{2 π k ( n - l )}{N}} + w ( n ) = \frac{1}{\sqrt{N}} {\sum }_{k} {d}_{k} {e}^{j \frac{2 π k n}{N}} {\sum }_{l} {h}_{l} ( n ) {e}^{- j \frac{2 π k l}{N}} + w ( n )$$

Note that the frequency domain channel vector is provided in accordance with:

$${H}_{k} ( n ) ≡ {\sum }_{l} {h}_{l} ( n ) {e}^{- j \frac{2 π k l}{N}}$$

$$Therefore :$$

$$y ( n ) = \frac{1}{\sqrt{N}} {\sum }_{k} {d}_{k} {H}_{k} ( n ) {e}^{j \frac{2 π k n}{N}} + w ( n )$$

$$Note that :$$

$${H}_{k} ( n ) {H}_{k}^{H} ( n ) = {\sum }_{{l}_{1}} {\sum }_{{l}_{2}} {h}_{{l}_{1}} ( n ) {h}_{{l}_{2}}^{H} ( n ) {e}^{- j \frac{2 π k ( {l}_{1} - {l}_{2} )}{N}}$$

Taking statistical expectation we obtain:

$$E \{ {H}_{k} ( n ) {H}_{k}^{H} ( n ) \} = E \{ {\sum }_{l} {h}_{l} ( n ) {h}_{l}^{H} ( n ) \} = {\sum }_{m , l} E \{ {\vert {h}_{m , l} ( n ) \vert}^{2} \} a ( {θ}_{m , l} ) {a}^{H} ( {θ}_{m , l} )$$

Therefore, we have:

$$R = E \{ y ( n ) {y ( n )}^{H} \} = {\sum }_{m , l} E \{ {\vert {h}_{m , l} ( n ) \vert}^{2} \} a ( {θ}_{m , l} ) {a}^{H} ( {θ}_{m , l} ) + {σ}^{2} I = E \{ {H}_{k} ( n ) {H}_{k}^{H} ( n ) \} + {σ}^{2} I$$

### Examples

The following examples pertain to various techniques of the present disclosure.

An example (e.g. example 1) relates to a computing device, comprising: a memory configured to store computer-readable instructions; and a processor configured to execute the computer-readable instructions to cause the computing device to: generate, via a multipath propagation channel model that applies a set of predefined signal parameters, training samples identified with a received wireless training signal; calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers; train a neural network (NN) using training data that comprises the training samples and the set of corresponding labels to generate a trained NN; perform inference via the trained NN to estimate channel state information (CSI) of a wireless channel and an angular spectrum (AS) identified with propagation of a received signal; and perform multiple-input multiple-output (MIMO) antenna beamforming using the CSI and the AS.

Another example (e.g. example 2) relates to a previously-described example (e.g. example 1), wherein the AS represents a distribution of received power at different angles of arrival of the received signal.

Another example (e.g. example 3) relates to a previously-described example (e.g. one or more of examples 1-2), wherein the computer-readable instructions, when executed the processor, cause the computing device to perform the inference to estimate one or more statistical channel parameters, and to estimate the CSI of the wireless channel identified with the propagation of the received signal based upon the estimated one or more statistical channel parameters.

Another example (e.g. example 4) relates to a previously-described example (e.g. one or more of examples 1-3), wherein the computer-readable instructions, when executed the processor, cause the computing device to further train the NN using training data that comprises the CSI, and to perform the inference to estimate the AS of the wireless channel based upon the estimated CSI in accordance with the further trained NN.

Another example (e.g. example 5) relates to a previously-described example (e.g. one or more of examples 1-4), wherein the NN comprises a domain knowledge enhanced neural network (DKE-NN).

Another example (e.g. example 6) relates to a previously-described example (e.g. one or more of examples 1-5), wherein the received signal is received via an antenna array, and wherein the computer-readable instructions, when executed the processor, cause the computing device to perform the inference by estimating the CSI per antenna by (i) computing an estimated power delay profile (PDP) per antenna of the antenna array, and (ii) computing an average of the estimated PDP per antenna.

Another example (e.g. example 7) relates to a previously-described example (e.g. one or more of examples 1-6), wherein the computer-readable instructions, when executed the processor, cause the computing device to perform the inference to estimate the AS that represents a distribution of received power at different angles of arrival with respect to the antenna array by (i) estimating an AS per sub-carrier identified with the received signal, (ii) averaging a covariance matrix over each one of the sub-carriers, and (iii) estimating the AS from the averaged covariance matrix.

Another example (e.g. example 8) relates to a previously-described example (e.g. one or more of examples 1-7), wherein the computer-readable instructions, when executed the processor, cause the computing device to perform the inference to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

An example (e.g. example 9) is directed to a device, comprising: processing circuitry configured to: compute an angular spectrum from channel state information (CSI) identified with a wirelessly received signal, the angular spectrum representing a distribution of received power at different angles of arrival; identify one or more main beam locations by determining locations within the angular spectrum at which the received power exceeds a received power level threshold; and compute a beamforming pattern that widens one or more main beams at the respective one of more main beam locations via a matrix decomposition process that operates on a matrix that is generated as a result of adding artificial power at one or more angular locations with respect to the one of more main beam locations; and a transceiver configured to perform a wireless signal transmission in accordance with the beamforming pattern.

Another example (e.g. example 10) relates to a previously-described example (e.g. example 9), wherein the processing circuitry is configured to generate, as the matrix, a widened spatial covariance matrix, and to compute the beamforming pattern as an eigen beamforming pattern by performing, as the decomposition process, an eigen decomposition on the widened spatial covariance matrix.

Another example (e.g. example 11) relates to a previously-described example (e.g. one or more of examples 9-10), wherein the eigen decomposition comprises a singular value decomposition to compute, as beamforming vectors identified with the beamforming pattern, wide eigenvectors from the widened spatial covariance matrix.

Another example (e.g. example 12) relates to a previously-described example (e.g. one or more of examples 9-11), wherein the eigen decomposition comprises a QR decomposition to compute, as beamforming vectors identified with the beamforming pattern, wide eigenvectors from the widened spatial covariance matrix.

Another example (e.g. example 13) relates to a previously-described example (e.g. one or more of examples 9-12), wherein the processing circuitry is configured to compute the beamforming pattern by computing, via the matrix decomposition process, beamforming vectors using, from the wirelessly received signal, a single Orthogonal Frequency-Division Multiplexing (OFDM) symbol carrying a Sounding Reference Signal (SRS).

Another example (e.g. example 14) relates to a previously-described example (e.g. one or more of examples 9-13), wherein the one or more angular locations with respect to the one of more main beam locations at which the artificial power is added is based upon a mobility level of a device from which the wirelessly received signal is transmitted.

Another example (e.g. example 15) relates to a previously-described example (e.g. one or more of examples 9-14), wherein the CSI is output via a trained domain knowledge enhanced neural network (DKE-NN), and wherein the trained DKE-NN is trained using training data that comprises training samples that are generated via a multipath propagation channel model and a set of corresponding labels, the labels including a maximum likelihood estimate (MLE) of power received in the quantized delay domain, a MLE of power received in the quantized angle of arrival domain, and corresponding Lagrange multipliers.

An example (e.g. example 16) is directed to a non-transitory computer-readable medium having instructions stored thereon, that when executed by processing circuitry of a computing device, cause the computing device to: generate, via a multipath propagation channel model that applies a set of predefined signal parameters, training samples identified with a received wireless training signal; calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers; train a domain knowledge enhanced neural network (DKE-NN) using training data that comprises the training samples and the set of corresponding labels to generate a trained DKE-NN; perform inference via the trained DKE-NN to estimate channel state information (CSI) of a wireless channel and an angular spectrum (AS) identified with propagation of a received signal; identify one or more main beam locations by determining locations within the AS at which the received power exceeds a received power level threshold; and compute a beamforming pattern using the CSI and the AS that widens one or more main beams at the respective one of more main beam locations via a matrix decomposition process that operates on a matrix that is generated as a result of adding artificial power at one or more angular locations with respect to the one of more main beam locations.

Another example (e.g. example 17) relates to a previously-described example (e.g. example 16), wherein the AS represents a distribution of received power at different angles of arrival of the received signal.

Another example (e.g. example 18) relates to a previously-described example (e.g. one or more of examples 16-17), wherein the computer-readable instructions, when executed the processing circuitry, cause the computing device to perform the inference via the trained DKE-NN to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

Another example (e.g. example 19) relates to a previously-described example (e.g. one or more of examples 16-18), wherein the computer-readable instructions, when executed the processing circuitry, cause the computing device to: calculate, as the matrix, a widened spatial covariance matrix; and compute the beamforming pattern as an eigen beamforming pattern by performing, as the decomposition process, an eigen decomposition on the widened spatial covariance matrix to compute, as beamforming vectors identified with the beamforming pattern, wide eigenvectors from the widened spatial covariance matrix, wherein the eigen decomposition comprises one of (i) a singular value decomposition, or (ii) a QR decomposition.

Another example (e.g. example 20) relates to a previously-described example (e.g. one or more of examples 16-19), wherein the computer-readable instructions, when executed the processing circuitry, cause the computing device to determine the angular location with respect to the one or more main beams at which the artificial power is added is based upon a mobility level of a device from which the wirelessly received signal is transmitted.

An example (e.g. example 21) relates to a computing device, comprising: a means for storing computer-readable instructions; and a processing means for executing the computer-readable instructions to cause the computing device to: generate, via a multipath propagation channel model that applies a set of predefined signal parameters, training samples identified with a received wireless training signal; calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers; train a neural network (NN) using training data that comprises the training samples and the set of corresponding labels to generate a trained NN; perform inference via the trained NN to estimate channel state information (CSI) of a wireless channel and an angular spectrum (AS) identified with propagation of a received signal; and perform multiple-input multiple-output (MIMO) antenna beamforming using the CSI and the AS.

Another example (e.g. example 22) relates to a previously-described example (e.g. example 21), wherein the AS represents a distribution of received power at different angles of arrival of the received signal.

Another example (e.g. example 23) relates to a previously-described example (e.g. one or more of examples 21-22), wherein the computer-readable instructions, when executed the processing means, cause the computing device to perform the inference to estimate one or more statistical channel parameters, and to estimate the CSI of the wireless channel identified with the propagation of the received signal based upon the estimated one or more statistical channel parameters.

Another example (e.g. example 24) relates to a previously-described example (e.g. one or more of examples 21-23), wherein the computer-readable instructions, when executed the processing means, cause the computing device to further train the NN using training data that comprises the CSI, and to perform the inference to estimate the AS of the wireless channel based upon the estimated CSI in accordance with the further trained NN.

Another example (e.g. example 25) relates to a previously-described example (e.g. one or more of examples 21-24), wherein the NN comprises a domain knowledge enhanced neural network (DKE-NN).

Another example (e.g. example 26) relates to a previously-described example (e.g. one or more of examples 21-25), wherein the received signal is received via an antenna array, and wherein the computer-readable instructions, when executed the processing means, cause the computing device to perform the inference by estimating the CSI per antenna by (i) computing an estimated power delay profile (PDP) per antenna of the antenna array, and (ii) computing an average of the estimated PDP per antenna.

Another example (e.g. example 27) relates to a previously-described example (e.g. one or more of examples 21-26), wherein the computer-readable instructions, when executed the processing means, cause the computing device to perform the inference to estimate the AS that represents a distribution of received power at different angles of arrival with respect to the antenna array by (i) estimating an AS per sub-carrier identified with the received signal, (ii) averaging a covariance matrix over each one of the sub-carriers, and (iii) estimating the AS from the averaged covariance matrix.

Another example (e.g. example 28) relates to a previously-described example (e.g. one or more of examples 21-27), wherein the computer-readable instructions, when executed the processing means, cause the computing device to perform the inference to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

An example (e.g. example 29) is directed to a device, comprising: a processing means for: computing an angular spectrum from channel state information (CSI) identified with a wirelessly received signal, the angular spectrum representing a distribution of received power at different angles of arrival; identifying one or more main beam locations by determining locations within the angular spectrum at which the received power exceeds a received power level threshold; and computing a beamforming pattern that widens one or more main beams at the respective one of more main beam locations via a matrix decomposition process that operates on a matrix that is generated as a result of adding artificial power at one or more angular locations with respect to the one of more main beam locations; and a transceiver means for performing a wireless signal transmission in accordance with the beamforming pattern.

Another example (e.g. example 30) relates to a previously-described example (e.g. example 29), wherein the processing means generates, as the matrix, a widened spatial covariance matrix, and computes the beamforming pattern as an eigen beamforming pattern by performing, as the decomposition process, an eigen decomposition on the widened spatial covariance matrix.

Another example (e.g. example 31) relates to a previously-described example (e.g. one or more of examples 29-30), wherein the eigen decomposition comprises a singular value decomposition to compute, as beamforming vectors identified with the beamforming pattern, wide eigenvectors from the widened spatial covariance matrix.

Another example (e.g. example 32) relates to a previously-described example (e.g. one or more of examples 29-31), wherein the eigen decomposition comprises a QR decomposition to compute, as beamforming vectors identified with the beamforming pattern, wide eigenvectors from the widened spatial covariance matrix.

Another example (e.g. example 33) relates to a previously-described example (e.g. one or more of examples 29-32), wherein the processing means computes the beamforming pattern by computing, via the matrix decomposition process, beamforming vectors using, from the wirelessly received signal, a single Orthogonal Frequency-Division Multiplexing (OFDM) symbol carrying a Sounding Reference Signal (SRS).

Another example (e.g. example 34) relates to a previously-described example (e.g. one or more of examples 29-33), wherein the one or more angular locations with respect to the one of more main beam locations at which the artificial power is added is based upon a mobility level of a device from which the wirelessly received signal is transmitted.

Another example (e.g. example 35) relates to a previously-described example (e.g. one or more of examples 29-34), wherein the CSI is output via a trained domain knowledge enhanced neural network (DKE-NN), and wherein the trained DKE-NN is trained using training data that comprises training samples that are generated via a multipath propagation channel model and a set of corresponding labels, the labels including a maximum likelihood estimate (MLE) of power received in the quantized delay domain, a MLE of power received in the quantized angle of arrival domain, and corresponding Lagrange multipliers.

An example (e.g. example 36) is directed to a non-transitory computer-readable medium having instructions stored thereon, that when executed by processing means of a computing device, cause the computing device to: generate, via a multipath propagation channel model that applies a set of predefined signal parameters, training samples identified with a received wireless training signal; calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers; train a domain knowledge enhanced neural network (DKE-NN) using training data that comprises the training samples and the set of corresponding labels to generate a trained DKE-NN; perform inference via the trained DKE-NN to estimate channel state information (CSI) of a wireless channel and an angular spectrum (AS) identified with propagation of a received signal; identify one or more main beam locations by determining locations within the AS at which the received power exceeds a received power level threshold; and compute a beamforming pattern using the CSI and the AS that widens one or more main beams at the respective one of more main beam locations via a matrix decomposition process that operates on a matrix that is generated as a result of adding artificial power at one or more angular locations with respect to the one of more main beam locations.

Another example (e.g. example 37) relates to a previously-described example (e.g. example 36), wherein the AS represents a distribution of received power at different angles of arrival of the received signal.

Another example (e.g. example 38) relates to a previously-described example (e.g. one or more of examples 36-37), wherein the computer-readable instructions, when executed the processing means, cause the computing device to perform the inference via the trained DKE-NN to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

Another example (e.g. example 39) relates to a previously-described example (e.g. one or more of examples 36-38), wherein the computer-readable instructions, when executed the processing means, cause the computing device to: calculate, as the matrix, a widened spatial covariance matrix; and compute the beamforming pattern as an eigen beamforming pattern by performing, as the decomposition process, an eigen decomposition on the widened spatial covariance matrix to compute, as beamforming vectors identified with the beamforming pattern, wide eigenvectors from the widened spatial covariance matrix, wherein the eigen decomposition comprises one of (i) a singular value decomposition, or (ii) a QR decomposition.

Another example (e.g. example 40) relates to a previously-described example (e.g. one or more of examples 36-39), wherein the computer-readable instructions, when executed the processing means, cause the computing device to determine the angular location with respect to the one or more main beams at which the artificial power is added is based upon a mobility level of a device from which the wirelessly received signal is transmitted.

An apparatus as shown and described.

A method as shown and described.

### CONCLUSION

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

The designs of the disclosure may be implemented in hardware (e.g., circuits), firmware, software, or any combination thereof. Designs may also be implemented as instructions stored on a machine-readable medium, which may be read and executed by one or more processors. A machine-readable medium may include any mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned data types and may take various forms and represent any information as understood in the art.

The terms “processor” or “controller” as used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). A processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

What is claimed is:

1. A computing device, comprising:
a memory configured to store computer-readable instructions; and
a processor configured to execute the computer-readable instructions to cause the computing device to:
generate, via a multipath propagation channel model that applies a set of predefined signal parameters, training samples identified with a received wireless training signal;
calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers;
train a neural network (NN) using training data that comprises the training samples and the set of corresponding labels to generate a trained NN;
perform inference via the trained NN to estimate channel state information (CSI) of a wireless channel and an angular spectrum (AS) identified with propagation of a received signal; and
perform multiple-input multiple-output (MIMO) antenna beamforming using the CSI and the AS.

2. The computing device of claim 1, wherein the AS represents a distribution of received power at different angles of arrival of the received signal.

3. The computing device of claim 1, wherein the computer-readable instructions, when executed the processor, cause the computing device to perform the inference to estimate one or more statistical channel parameters, and to estimate the CSI of the wireless channel identified with the propagation of the received signal based upon the estimated one or more statistical channel parameters.

4. The computing device of claim 1, wherein the computer-readable instructions, when executed the processor, cause the computing device to further train the NN using training data that comprises the CSI, and to perform the inference to estimate the AS of the wireless channel based upon the estimated CSI in accordance with the further trained NN.

5. The computing device of claim 1, wherein the NN comprises a domain knowledge enhanced neural network (DKE-NN).

6. The computing device of claim 1, wherein the received signal is received via an antenna array, and
wherein the computer-readable instructions, when executed the processor, cause the computing device to perform the inference by estimating the CSI per antenna by (i) computing an estimated power delay profile (PDP) per antenna of the antenna array, and (ii) computing an average of the estimated PDP per antenna.

7. The computing device of claim 4, wherein the computer-readable instructions, when executed the processor, cause the computing device to perform the inference to estimate the AS that represents a distribution of received power at different angles of arrival with respect to the antenna array by (i) estimating an AS per sub-carrier identified with the received signal, (ii) averaging a covariance matrix over each one of the sub-carriers, and (iii) estimating the AS from the averaged covariance matrix.

8. The computing device of claim 1, wherein the computer-readable instructions, when executed the processor, cause the computing device to perform the inference to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

9. A computing device, comprising:
processing circuitry configured to:
compute an angular spectrum from channel state information (CSI) identified with a wirelessly received signal, the angular spectrum representing a distribution of received power at different angles of arrival;
identify one or more main beam locations by determining locations within the angular spectrum at which the received power exceeds a received power level threshold; and
compute a beamforming pattern that widens one or more main beams at the respective one of more main beam locations via a matrix decomposition process that operates on a matrix that is generated as a result of adding artificial power at one or more angular locations with respect to the one of more main beam locations; and
a transceiver configured to perform a wireless signal transmission in accordance with the beamforming pattern.

10. The computing device of claim 9, wherein the processing circuitry is configured to generate, as the matrix, a widened spatial covariance matrix, and to compute the beamforming pattern as an eigen beamforming pattern by performing, as the decomposition process, an eigen decomposition on the widened spatial covariance matrix.

11. The computing device of claim 10, wherein the eigen decomposition comprises a singular value decomposition to compute, as beamforming vectors identified with the beamforming pattern, wide eigenvectors from the widened spatial covariance matrix.

12. The computing device of claim 10, wherein the eigen decomposition comprises a QR decomposition to compute, as beamforming vectors identified with the beamforming pattern, wide eigenvectors from the widened spatial covariance matrix.

13. The computing device of claim 9, wherein the processing circuitry is configured to compute the beamforming pattern by computing, via the matrix decomposition process, beamforming vectors using, from the wirelessly received signal, a single Orthogonal Frequency-Division Multiplexing (OFDM) symbol carrying a Sounding Reference Signal (SRS).

14. The computing device of claim 9, wherein the one or more angular locations with respect to the one of more main beam locations at which the artificial power is added is based upon a mobility level of a device from which the wirelessly received signal is transmitted.

15. The computing device of claim 9, wherein the CSI is output via a trained domain knowledge enhanced neural network (DKE-NN), and
wherein the trained DKE-NN is trained using training data that comprises training samples that are generated via a multipath propagation channel model and a set of corresponding labels, the labels including a maximum likelihood estimate (MLE) of power received in the quantized delay domain, a MLE of power received in the quantized angle of arrival domain, and corresponding Lagrange multipliers.

16. A non-transitory computer-readable medium having instructions stored thereon, that when executed by processing circuitry of a computing device, cause the computing device to:
generate, via a multipath propagation channel model that applies a set of predefined signal parameters, training samples identified with a received wireless training signal;
calculate, from the training samples, a set of corresponding labels, wherein the set of corresponding labels include a maximum likelihood estimate (MLE) of power received in a quantized delay domain, a MLE of power received in a quantized angle of arrival domain, and corresponding Lagrange multipliers;
train a domain knowledge enhanced neural network (DKE-NN) using training data that comprises the training samples and the set of corresponding labels to generate a trained DKE-NN;
perform inference via the trained DKE-NN to estimate channel state information (CSI) of a wireless channel and an angular spectrum (AS) identified with propagation of a received signal;
identify one or more main beam locations by determining locations within the AS at which the received power exceeds a received power level threshold; and
compute a beamforming pattern using the CSI and the AS that widens one or more main beams at the respective one of more main beam locations via a matrix decomposition process that operates on a matrix that is generated as a result of adding artificial power at one or more angular locations with respect to the one of more main beam locations.

17. The non-transitory computer-readable medium of claim 16, wherein the AS represents a distribution of received power at different angles of arrival of the received signal.

18. The non-transitory computer-readable medium of claim 17, wherein the computer-readable instructions, when executed the processing circuitry, cause the computing device to perform the inference via the trained DKE-NN to estimate one or more statistical channel parameters and corresponding Lagrange multipliers, and to estimate the CSI by applying Karush Kuhn Tucker (KKT) conditions to the one or more statistical channel parameters and corresponding Lagrange multipliers.

19. The non-transitory computer-readable medium of claim 16, wherein the computer-readable instructions, when executed the processing circuitry, cause the computing device to:
calculate, as the matrix, a widened spatial covariance matrix; and
compute the beamforming pattern as an eigen beamforming pattern by performing, as the decomposition process, an eigen decomposition on the widened spatial covariance matrix to compute, as beamforming vectors identified with the beamforming pattern, wide eigenvectors from the widened spatial covariance matrix,
wherein the eigen decomposition comprises one of (i) a singular value decomposition, or (ii) a QR decomposition.

20. The non-transitory computer-readable medium of claim 16, wherein the computer-readable instructions, when executed the processing circuitry, cause the computing device to determine the angular location with respect to the one or more main beams at which the artificial power is added is based upon a mobility level of a device from which the wirelessly received signal is transmitted.
